(19) United States
(12) Patent Application Publication
(10) Pub. No.: US 2026/0359236 A1
(43) Pub. Date: Nov. 12, 2026

(54) NETWORK CONFIGURATION UTILIZING A CONTAINER STORAGE INTERFACE DRIVER

(71) Applicant: Oracle International Corporation, Redwood Shores, CA (US)

(72) Inventors: Mrunal Mahesh Pagnis, Pune (IN); Dhananjay Gangadhar Nagargoje, Beed (IN); Sachin Goel, Ghaziabad (IN); Vadakkumuri Valappil Aboobacker, Natick, MA (US)

(73) Assignee: Oracle International Corporation, Redwood Shores, CA (US)

(21) Appl. No.: 19/205,411

(22) Filed: May 12, 2025

(51) Int. Cl. G06F 13/10

(52) U.S. Cl. CPC G06F 13/102; G06F 2213/40

(57) ABSTRACT

An enhanced Container Storage Interface (CSI) driver of a container orchestration platform (COP) is disclosed, as are systems, devices, and methods that may utilize the CSI driver. In contrast to conventional CSI drivers that provide limited functionality, the disclosed CSI driver enables a configuration process to be executed that configures the computing device on which the CSI driver executes to communicate via a dedicated network of a distributed file system (e.g., Lustre). The configuration process may occur as part of staging a persistent volume (e.g., a Lustre storage volume) for use by a containerized application. The configuration process may be re-executed if the configuration is unsuccessful, or when a workload corresponding to the containerized application is restarted, enabling network recovery in the event of network disruptions and allowing successful network configuration even if the configuration process is initiated while corresponding network interface is unavailable.

### BACKGROUND

Cloud computing platforms provide scalable and flexible computing resources for users. Cloud computing platforms can provide one or more categories of services, including Software as a Service (SaaS), Platform as a Service (PaaS), or Infrastructure as a Service (IaaS). Under an IaaS cloud service model, one or more types of resources are hosted by a cloud service provider and made available to a client for use. Such resources can include computing resources (e.g., compute instances), networking resources (e.g., a virtual private network), storage resources (e.g., persistent volumes), and other hardware or software resources.

Some users may wish to utilize computing resources to implement a distributed parallel file system (e.g., Lustre) that utilizes a Lustre Network. A “Lustre Network” (also referred to as “LNet”), is a high-speed data network protocol used for communication between Lustre clients and servers within the distributed parallel file system. LNet is designed to support large-scale compute clusters and is designed for scalability, high performance, and high availability. Lustre client packages and LNet must be properly configured on worker nodes before the file system may be utilized. Configuring nodes for Lustre Networking is non-trivial and conventional solutions result in race conditions where LNet setup may be attempted prior to network interface availability. These attempts lead to setup failures and subsequent failures in mounting Lustre file systems.

### BRIEF SUMMARY

In the following description, for the purposes of explanation, specific details are set forth in order to provide a thorough understanding of certain embodiments. However, it will be apparent that various embodiments may be practiced without these specific details. The figures and description are not intended to be restrictive.

Some embodiments may include a computer-implemented method (a “method”). The method may comprise receiving, by a computing device configured with a container storage interface (CSI) driver and in communication with a container orchestration platform, a request to stage a persistent volume that is associated with a distributed file system. In some embodiments, the persistent volume is to be utilized by a containerized application at the computing device. The method may comprise executing, by the computing device, a first execution of a configuration process of the CSI driver. In some embodiments, the configuration process is associated with configuring the computing device to communicate over a network that is dedicated to communications associated with the distributed file system. The method may comprise determining, by the computing device, whether the computing device was successfully configured to communicate over the network. In some embodiments, a second execution of the configuration process is initiated based at least in part on a reconciliation mechanism of the container orchestration platform when configuring the computing device to communicate over the network was unsuccessful.

In some embodiments, the request is formatted according to a node stage volume request of a container storage interface protocol.

In some embodiments, the distributed file system is a Lustre parallel distributed file system and the network utilizes a Lustre networking protocol.

In some embodiments, executing the configuration process comprises 1) initiating, by the computing device, execution of a network service based at least in part on an image installed at the computing device, 2) identifying, by the network service executing at the computing device, an identifier for the network, the identifier being identified based at least in part on a persistent volume specification that is associated with the persistent volume to which the request relates, and 3) determining, by the network service and based at least in part on the identifier, whether the computing device has been previously configured to communicate via the network.

In some embodiments, executing the configuration process further comprises deleting a previous network configuration when the computing device has been previously configured to communicate via the network. In some embodiments, the previous network configuration is deleted based at least in part on determining that a first network identifier, a first Internet Protocol (IP) address, or a first virtual network interface identifier of the previous network configuration fails to match a second network identifier, a second IP address, or a second virtual network interface identifier with which configuration is being attempted by the configuration process.

In some embodiments, executing the configuration process comprises identifying a subnet range associated with the network. In some embodiments, the subnet range is identified based at least on a subnet cross inter-domain routing (CIDR) that is associated with the persistent volume. Executing the configuration process may comprise executing one or more operations to identify virtual network interface data associated with one or more virtual network interfaces attached to the computing device. In some embodiments, executing the configuration process comprises identifying a virtual network interface identifier to be used for the configuration process based at least in part on identifying a virtual network interface of the one or more virtual network interfaces that falls within the subnet range associated with the network.

A computing device is disclosed. The computing device may execute a container storage interface (CSI) driver and may be in communication with a container orchestration platform. In some embodiments, the computing device may comprise one or more processors and one or more memories storing computer-executable instructions that, when executed by the one or more processors, cause the one or more processors to perform operations. The operations may comprise receiving a package manifest (e.g., a manifest of a Kubernetes pod) that is associated with one or more containers to be executed at the computing device,. In some embodiments, the package manifest identifies a persistent volume that is associated with a distributed file system. The operations may comprise executing a configuration process provided by the CSI driver based at least in part on receiving the package manifest. In some embodiments, the configuration process is associated with configuring the computing device to communicate over a network that is dedicated to communications associated with the distributed file system. In some embodiments, executing the configuration process causes the one or more processors to 1) identify a subnet range for the network from a persistent volume specification that is associated with the persistent volume, 2) identify a virtual network interface attached to the computing device that falls within the subnet range, and 3) when the virtual network interface is successfully identified, add an entry that identifies the virtual network interface to network configuration data that is associated with the network. The operations executed by the one or more processors may comprise validating that the computing device was successfully configured to communicate over the network based at least in part on the network configuration data.

In some embodiments, executing the computer-executable instructions that identify the virtual network interface, further causes the one or more processors to execute a network input/output package function (e.g., a function of a golang net package) that is configured to collect network interface data associated with one or more virtual network interfaces attached to the computing device. In some embodiments, the network interface data comprises a respective network identifier of each of the one or more virtual network interfaces and a respective Internet Protocol (IP) address corresponding to each of the one or more virtual network interfaces.

In some embodiments, the container orchestration platform is a Kubernetes orchestration platform.

In some embodiments, the package manifest is received as part of initiating or restarting execution of the one or more containers at the computing device.

In some embodiments, the distributed file system is a parallel distributed file system (e.g., Lustre) that allows distributed applications to read and write to a single file simultaneously.

In some embodiments, executing the configuration process causes the one or more processors to 1) determine that no virtual network interface that falls within the subnet range is attached to the computing device, 2) halt execution of the configuration process based at least in part on determining that no virtual network interface that falls within the subnet range is attached to the computing device, and 3) transmit an error indicating that the configuration process was unsuccessful. In some embodiments, execution of the configuration process is subsequently reinitiated by the container orchestration platform based at least in part on transmitting the error.

A non-transitory computer readable medium is disclosed. The non-transitory computer-readable medium may store computer-executable instructions associated with a container storage interface driver of a data plane associated with a container orchestration platform that, when executed by one or more processors of a computing device, cause the one or more processors to perform operations. The operations may include receiving a request to stage a persistent volume for use with a containerized application executing at the computing device. In some embodiments, the persistent volume is associated with a distributed file system that utilizes a dedicated network, the dedicated network being dedicated to communications between devices of the distributed file system. The operations may comprise determining, from attributes that are associated with the persistent volume to be staged, a network identifier and a subnet range corresponding to the dedicated network. The operations may comprise identifying a network interface that is attached to the computing device based at least in part on the subnet range. The operations may comprise configuring the computing device to communicate via the dedicated network based at least in part on adding the network identifier and an identifier of the network interface to network configuration data corresponding to the dedicated network. The operations may comprise, in response to successfully configuring the computing device to communicate via the dedicated network, mounting the persistent volume to the computing device. In some embodiments, mounting the persistent volume causes the persistent volume to be accessible to the containerized application.

In some embodiments, executing the computer-executable instructions further causes the one or more processors to obtain the attributes associated with the persistent volume from a persistent volume specification that is maintained by the container orchestration platform.

In some embodiments, configuring the computing device to communicate via the dedicated network is performed in response to receiving the request to stage the persistent volume.

In some embodiments, the request to stage the persistent volume is received as part of a process to restart a workload corresponding to the containerized application.

In some embodiments, executing the computer-executable instructions that configure the computing device to communicate via the dedicated network further causes the one or more processors to 1) obtain current network configuration data corresponding to the dedicated network, the current network configuration data indicating whether the network interface is currently configured for use with the dedicated network and a state of the dedicated network, 2) identify that the current network configuration data fails to match the network identifier, and 3) delete the current network configuration data based at least in part on identifying that the current network configuration data fails to match the network identifier.

In some embodiments, executing the computer-executable instructions further causes the one or more processors to execute a network service module corresponding to the dedicated network, wherein the computing device is configured to communicate via the dedicated network based at least in part on executing operations of the network service module.

Systems, devices, and computer readable media are disclosed, each of which may comprise one or more memories on which instructions corresponding to the methods disclosed herein may be stored. The instructions may be executed by one or more processors of the disclosed systems and devices to execute the methods disclosed herein. One or more computer programs can be configured to perform operations corresponding to the described methods by virtue of including instructions that, when executed one or more processors, cause the one or more processors to perform the operations.

### BRIEF DESCRIPTION OF THE DRAWINGS

To easily identify the discussion of any particular element or act, the most significant digit or digits in a reference number refer to the figure number in which that element is first introduced.

FIG. 1 is a block diagram for illustrating an example architecture 100 for a container orchestration platform that may be utilized to manage containerized workloads in a cloud computing environment, in accordance with at least one embodiment.

FIG. 2 is an example persistent volume specification, in accordance with at least one embodiment.

FIG. 3 is an example persistent volume claim, in accordance with at least one embodiment.

FIG. 4 is an example package manifest that references a persistent volume claim, in accordance with at least one embodiment.

FIG. 5 depicts a code segment illustrating example setup operations, in accordance with at least one embodiment.

FIG. 6 is a flow diagram illustrating an example method for configuring LNet at a worker node, in accordance with at least one embodiment.

FIG. 7 is a block diagram illustrating an example method for configuring a worker node to execute as part of a network that is associated with a distributed file system, in accordance with at least one embodiment.

FIG. 8 is a block diagram illustrating one pattern for implementing a cloud infrastructure as a service system, according to at least one embodiment.

FIG. 9 is a block diagram illustrating another pattern for implementing a cloud infrastructure as a service system, according to at least one embodiment.

FIG. 10 is a block diagram illustrating another pattern for implementing a cloud infrastructure as a service system, according to at least one embodiment.

FIG. 11 is a block diagram illustrating another pattern for implementing a cloud infrastructure as a service system, according to at least one embodiment.

FIG. 12 is a block diagram illustrating an example computer system, according to at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Infrastructure as a service (IaaS) is one type of cloud computing. IaaS can be configured to provide virtualized computing resources over a public network (e.g., the Internet). In an IaaS model, a cloud computing provider can host infrastructure components (e.g., servers, storage devices, network nodes (e.g., hardware), or the like). The provisioning of and deployment to these infrastructure components can be managed by a service (e.g., (e.g., Oracle Kubernetes Engine (OKE)) using a container orchestration platform (e.g., Kubernetes) that automates deployment, scaling, and management of containerized applications/workloads (e.g., applications and/or workloads provided via a container) on physical devices and/or virtual machines. A “container” refers to a self-contained and portable unit of software that bundles code, runtime, libraries, system tools, and the like, allowing applications to run reliability across different environments. The container orchestration platform may utilize “packages” which individually include a group of one or more containers, with shared storage and network resources, and a specification for how to run the containers. A package may correspond to a Kubernetes pod, or any suitable grouping of containers utilized by a container orchestration platform.

Some users may wish to implement a parallel distributed file system using cloud resources. A parallel distributed file system distributes data across multiple servers and allows for parallel reads and writes, which can significantly increase performance compared to traditional systems that lack parallel read/write functionality. Lustre, an example parallel distributed file system, enables scalable storage and data access that is designed for high-performance computing and large-scale cluster computing. Lustre clients and servers communicate with one another using a Lustre Network (“LNet”), a high-speed data network protocol designed to support large-scale compute clusters and high-performance applications.

To configure a Lustre filesystem within the cloud, installation of Lustre client packages is needed at respective worker nodes of a cluster. Additionally, LNet must be properly configured to enable communication between Lustre clients and servers. Conventionally, the configuration of LNet at these worker nodes was performed via a manual process or by executing a script. However, as LNet setup requires network interface availability, these operations failed and corresponding failures in mounting Lustre file system volumes were experienced when the LNet setup operations were performed before the network interfaces became available at the worker node. Additionally, in the event of network failures, LNet can go down. Conventionally, reconfiguring LNet in these cases required manual intervention, which is impractical and error prone in large-scale clusters with thousands of nodes.

The disclosed techniques for configuring LNet address the drawbacks and failures of conventional approaches. In some embodiments, LNet setup operations may be performed by the Lustre CSI driver at a respective worker node. LNet configuration data (e.g., a LNet label, a Lustre subnet Classless Inter-Domain Routing (CIDR), etc.) may be an attribute associated with a persistent volume. A persistent volume (PV) refers to storage of the cluster that has been provisioned by an administrator or dynamically provisioned using storage classes. A PV represents a cluster storage resource that has a lifecycle that is independent of any package that uses the resource. PVs are individually associated with a PV specification that details the attribute of the PV storage resource. A user may request this storage resource using a Persistent Volume Claim (PVC). A PVC may provide various attributes (e.g., size, access mode, storage class, etc.) of the requested PV and may be matched to a suitable PV based on matching their respective attributes. When a PV is identified, the container orchestration platform may bind the PV and PVC and schedule a corresponding package for execution at the worker node. The Lustre CSI driver at the worker node may be invoked to stage the persistent volume and a process for setting up LNet may be attempted during this staging process. If a failure occurs when attempting to mount the volume (e.g., due to a corresponding network interface being unavailable or another suitable failure experienced during the LNet setup process), the container orchestration platform may utilize its reconciliation mechanism to retry the volume mount any suitable number of times until successful. By embedding LNet setup operations within the operations performed by the Lustre CSI driver, the race condition observed in conventional systems is avoided. While the volume mount may initially fail, the automatic retry functionality of the container orchestration platform (e.g., the container orchestration platform's “reconciliation mechanism”) may ensure that the mount will eventually succeed after the network interface becomes available.

The disclosed techniques integrate LNet setup and management within the Lustre CSI node driver, aligning with the container orchestration platform's reconciliation mechanism and the CSI specification. As a result, the process can wait for the network interface to become available before proceeding, ensuring that LNet is correctly configured without manual intervention or external scripting. The disclosed driver may monitor the status of the LNet interfaces and automatically re-configure them whenever a new mount is requested or when a workload is restarted. This ensures that LNet remains functional even after network disruptions, significantly improving reliability and reducing manual maintenance. These techniques are particularly valuable in large-scale environments (e.g., clusters with thousands of worker nodes), where manual or script-based setups are prone to errors and inefficiencies. The methods described herein reduce downtime, minimize manual intervention and reduce the risk of human error, while ensuring consistent and reliable access to Lustre filesystems in dynamic and complex clusters.

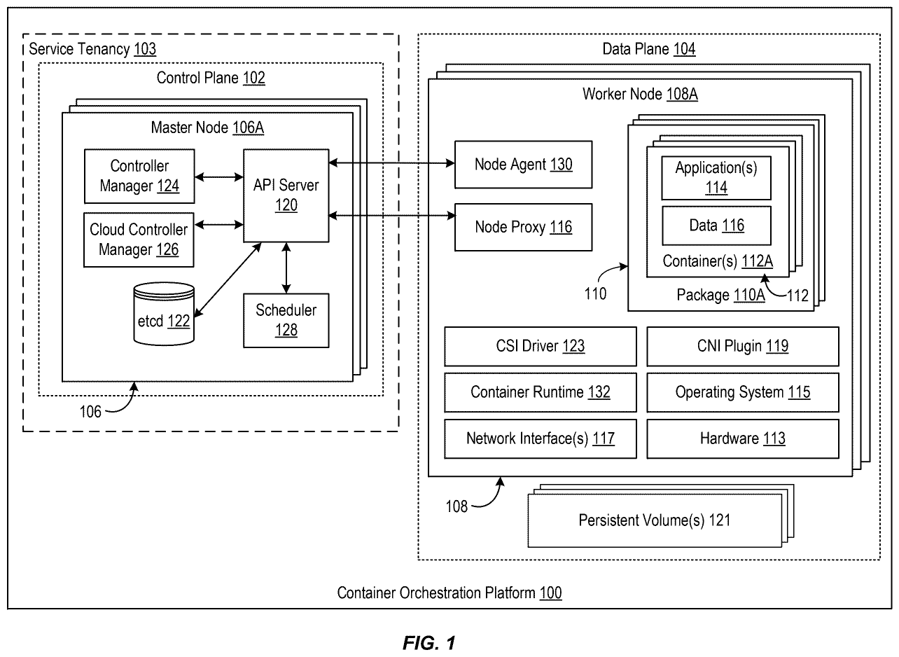

FIG. 1 is a block diagram for illustrating an example architecture for a container orchestration platform 100 that may be utilized to manage containerized workloads in a cloud computing environment, in accordance with at least one embodiment. Container orchestration platform 100 (e.g., an example of Kubernetes), may be configured to manage containerized workloads and services that facilitates declarative configuration and automation. Container orchestration platform 100 may provide an architecture that consists of a control plane 102 (e.g., a Kubernetes control plane) and data plane 104 (e.g., a Kubernetes data plane). Control plane 102 may include any suitable number of control plane components at master nodes 106, of which master node 106A serves as an example. Data plane 104 may include any suitable number of data plane components operating at worker nodes 108 (e.g., at worker node 108A). The components of control plane 102 may be hosted in service tenancy 103 (e.g., a tenancy that is associated with a service provided by a cloud provider, such as Oracle Kubernetes Engine) and may be responsible for container orchestration and maintaining the desired state of the cluster to which worker nodes 108 belong. Worker nodes 108 may be configured to execute containerized workloads via packages 110 (e.g., package 110A). Each of packages 110 (e.g., package 110A) may represent a containerized workload that includes any suitable number of containers 112 (e.g., container(s) 112A) that individually encapsulate the code of one or more applications (e.g., application(s) 114) with runtime, libraries, system tools, and/or the like, (e.g., data 116) that are needed to execute the application(s). Package 110A may be an example of a Kubernetes pod in examples in which Kubernetes is the platform utilized for container orchestration platform 100.

Container(s) 112A may execute on hardware 113 of the same node and share the operating system of the worker node (e.g., operating system 115) among the applications (e.g., application(s) 114). A container may have its own filesystem, share of the CPU, memory, process space, and other resources of the worker node 108A. The container runtime 132 may manage the containers at the worker node 108A. The container(s) 112A may be packaged together in one or more packages (e.g., package 110A) to maximize the benefits of resource sharing, where all of the containers of a package share the same resources and local network. Grouping containers this way allows the containers of a package to communicate between each other as if they shared the same physical hardware, while still remaining isolated to some degree. As the containers are decoupled from the underlying infrastructure, they may be portable across clouds and environments with differing operating systems.

Application(s) 114 and/or other components of the worker node 108A may be configured to communicate with other worker nodes, applications, and/or components via network interface(s) 117. Network interface(s) 117 may be managed by container network interface (CNI) plugin 119. CNI plugin 119 may be configured to configure network interfaces for packages 110 by creating virtual ethernet interfaces (e.g., “veth” pairs), assigning IP addresses to the interfaces, and setting up routes. In some embodiments, network interface(s) 117 may include a primary virtual network interface card (VNIC) and, in some cases, a secondary VNIC. In some embodiments, the secondary VNIC is intended to be utilized for Lustre network communications.

The components of control plane 102 and data plane 104 may interact to carry out various functions such as: spawning new packages, communicating the status of packages 110 and/or worker nodes 108, configuring networking components for packages 110, configuring persistent storage (e.g., a persistent volume) for package use, managing the lifecycle of packages 110 and corresponding persistent storage, among others functions.

API server 120 may expose a set of APIs (e.g., HTTP Rest APIs) for communicating with the control plane 102. API server 120 may be highly scalable and designed to handle a large number of concurrent requests. The API server 120 may be configured to communicate with other components of the control plane 102 via remote procedure calls (e.g., gRPC). In some embodiments, communications between API server 120 and components of the data plane 104 may be performed via a Transport Layer Security (TLS) connection (e.g., a communication channel that utilizes a TLS protocol to encrypt data being communicated via the channel) for privacy and security purposes. API server 120 may be configured to expose a cluster API endpoint and handle API requests provided via the endpoint. API server 120 may coordinate processes between the control plane 102 and the worker nodes 108 of data plane 104. In some embodiments, API server 120 may be configured to receive cluster data from data plane 104 that describes the state of the resources of data plane 104 (e.g., the state of packages 110 and/or nodes 108) and may store such cluster data in etcd 122. API server 120 may watch for changes to cluster data over time.

Etcd 122 may be a distributed key/value storage used by control plane 102 to store cluster data. Etcd 122 may store all configurations, states, and metadata of various objects (e.g., packages/pods, daemonsets, deployments, secrets, statefulset, etc.) utilized by the container orchestration platform 100. Etcd 122 may interact with API server 120 to enable the state of an object to be tracked. Etcd 122 may be configured to utilize a consensus algorithm (e.g., reliable, replicated, redundant, and fault-tolerant (RAFT) algorithm) to elect a leader and to achieve strong data consistency. Etcd 122 may be regularly backed up for disaster recovery according to any suitable predefined schedule or frequency.

Controller manager 124 may include any suitable number of the controllers (not depicted), such as replication controller, a package (pod) controller, a namespace controller, or the like as a part of its binaries. Controller manager 124 may execute a control loop that monitors current cluster state (e.g., maintained in etcd 122) and automatically executes operations for bringing the current cluster state in line with a desired state (e.g., a desired state declared in a manifest received by API server 120). For example, upon manual deletion of a package (e.g., pod), the controller manager 124, or a controller of the controller manager 124, may be configured to attempt spin up a new package to modify the cluster state to match a number of packages (corresponding to a “Replica Count”) to that of a desired state (corresponding to a “Replica Spec”). Some example controllers include: a node controller (e.g., a controller responsible for noticing and responding when nodes go down), a package controller (e.g., a controller responsible for noticing and responding when packages go down), a job controller (e.g., a controller configured to watch for job objects that represent one-off tasks, to name a few.

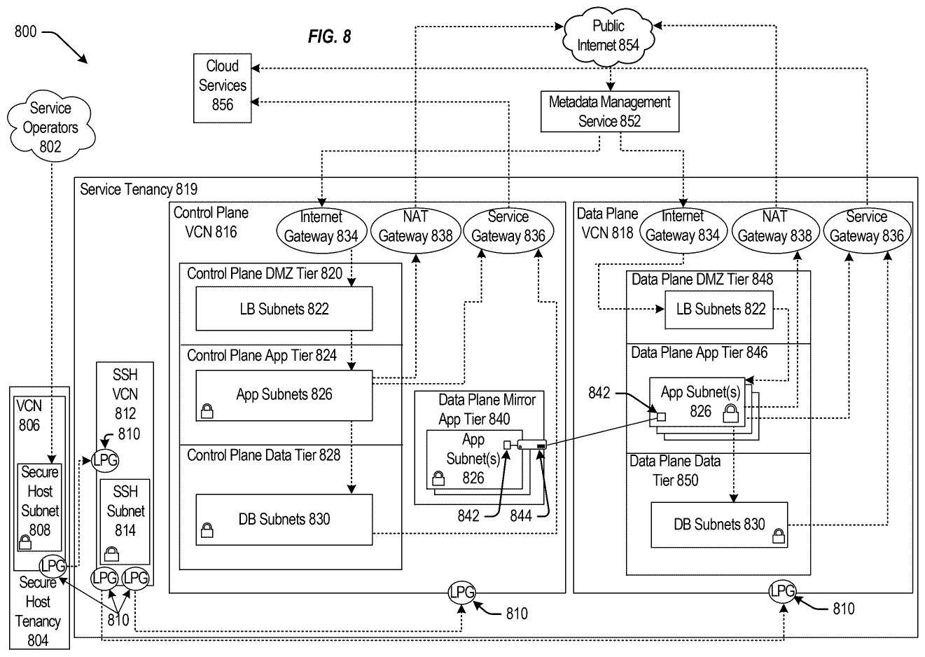

Cloud controller 126 may be a controller that is configured to act as a bridge between a cloud platform (e.g., a cloud environment conforming to the patterns 800-1100 of FIGS. 8-11, for example, an IaaS cloud environment such as Oracle Cloud Infrastructure), and the container orchestration platform 100. The functionality provided by cloud controller 126 may enable the components of the control plane 102 to provision cloud resources like virtual machine instances, load balancers, and persistent storage volumes (e.g., persistent storage volume(s) 121). Cloud controller 126 may include any suitable number of sub-controllers for managing the desired state of these cloud resources. For example, cloud controller 126 may include a node controller configured to interface with a resource manager via a cloud provider API to perform node labeling, to obtain hostname or other attributes of the worker nodes 108, and to determine node CPU and memory availability, node health, and the like. As another example, cloud controller 126 may include a service controller configured to interface with a resource manager via a cloud provider API to deploy services, assign IP addresses, and the like. The cloud controller 126 may include a route controller that configures networking routing for the worker nodes 108. In some embodiments, the route controller may communicate with CNI plugin 119 via node agent 130 to configure network interfaces 117. A kubelet of a Kubernetes orchestration platform may be an example of the node agent 130.

Scheduler 128, a controller managed by the controller manager 124, may be configured to assign/schedule packages (e.g., package 110A) to execute at cluster nodes (e.g., worker node 108A). Upon creating a new package (e.g., a pod), the scheduler 128 may compile a list of feasible nodes (a “candidate list”) in which the package can be placed. This is referred to as “filtering.” The nodes in the candidate list may be scored based on constraints and criteria (e.g., based on individual and collective resource requirements, hardware/software/policy constraints, affinity and anti-affinity specifications, data locality, inter-workload interference, and/or deadlines). The package (e.g., package 110A) may be assigned to the node with the highest score (e.g., worker node 108A). The scheduler 128 may bind (e.g., create a one-to-one mapping between) a package and a selected node and notify the API Server 120 of the assignment decision. Binding a package and a worker node may apply the corresponding change to the cluster.

The API server 120 may be configured to handle communicating with the selected node's agent (e.g., node agent 130) to spawn the package (e.g., package 110A) and deploy its containers (e.g., container(s) 112A). The node agent of each node may use a secure communication channel to the control plane 120 and presents authorization credentials, which grant it the privileges it needs to carry out the communication. The node agent 130 may communicate with container runtime 132 via a container runtime interface (e.g., defined by an interface specification) to manage packages.

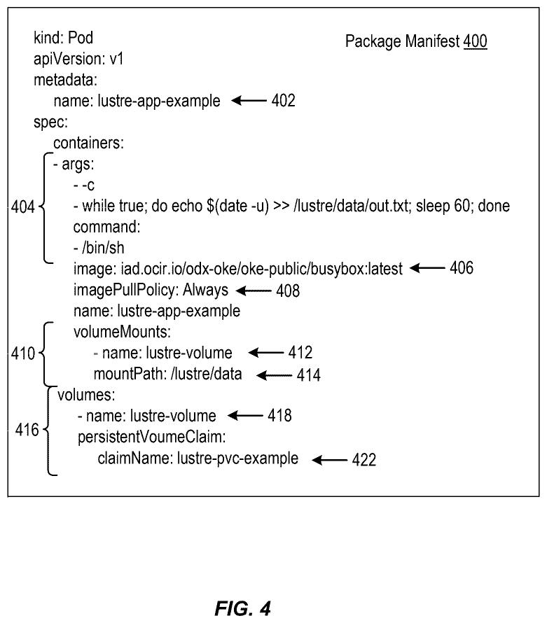

In some embodiments, the node agent 130 may be configured to ensure that containers are running in a package. The node agent 130 may obtain package manifests for packages 110 (e.g., package manifest 400 of FIG. 4, corresponding to package 110A) to ensure that the containers described in those package manifests are running and are healthy. Node agent 130 may create, modify, and delete containers for a package/pod, start probes, and handle status updates to API server 120. Node agent 130 may watch for package changes and utilize container runtime 115 (via a container runtime interface, a gRPC interface) to pull images, run containers, and the like. In some cases, node agent 130 may be responsible for mounting volumes by reading a package manifest (e.g., package manifest 400 of FIG. 4) and creating directories on the worker node for the volume mount. Node agent 130 may be configured to communicate with the CNI plugin 119 to allocate the package IP address and set up network routes and firewall rules for the package 110A.

Node proxy 132 may be a network proxy that runs on each worker node and maintains network rules on each node. These network rules allow network communication to these packages from network sessions inside or outside the cluster (e.g., a cluster of nodes including the nodes 108). The node proxy 132 may be a daemon that runs on every work node as a daemonset. Node proxy 132 may communicate with the API server 120 (via a TLS connection) to obtain package IP addresses and endpoint ports and monitors this data over time. Node proxy 132 may be used to maintain network rules for a group of packages of a cluster. A kube proxy of the Kubernetes orchestration platform may be an example of the node proxy 132.

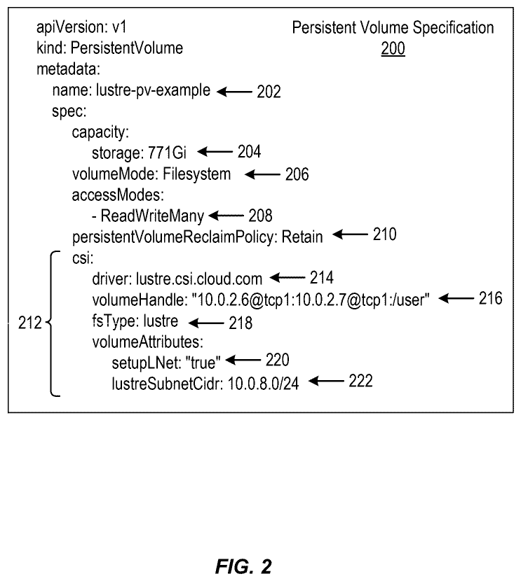

CSI driver 123 may be configured to communicate with node agent 130 (e.g., via gRPC). CSI driver 123 may be configured to bind and mount volumes (e.g., persistent volume(s) 121). In some embodiments, persistent volume(s) 121 may represent physical and/or virtual storage that has been provisioned. Persistent volume(s) 121 may individually associated with persistent volume metadata (e.g., PV metadata 200 of FIG. 2) which describes various attributes (e.g., the filesystem, the size, the access mode, etc.) of the represented storage volume. Persistent volume(s) 121 are intended to represent any suitable number of storage volumes that are configured to implement the Lustre filesystem. Conventionally, CSI drivers focus only on binding and mounting operations and do not contemplate processing steps that might be necessary depending on context (e.g., based on the type of file storage system being used by the volume). In conventional systems, LNet was manually set up at worker node 108A or a script was manually executed to attempt LNet setup at worker node 108A.

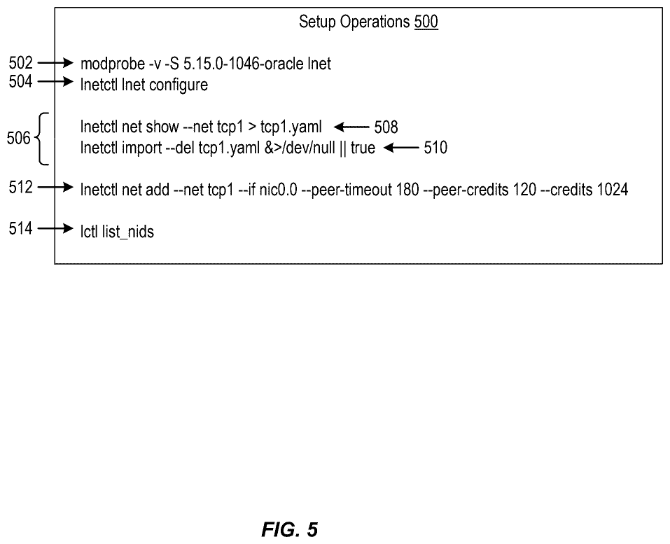

In some embodiments, CSI driver 123 represents an enhanced driver that conforms to the Container Storage Interface (e.g., a standard that enables different storage systems to be used with the container orchestration platform 100 by providing a unified API for volume operations) but that additionally may be configured to perform operations for automated set up and/or repair of a Lustre network. Setting up and/or repairing a Lustre network may include loading a LNet kernel module (not depicted) on worker node 108A, initializing the LNet service in the kernel, deleting any stale LNet configuration data, adding a name of the network interface of the worker node on which the package 110A (e.g., a Kubernetes pod) operates to LNet configuration data, and verifying the success/failure of the setup operations, among other operations. LNet setup operations are discussed in more detail with respect to FIG. 5 and are not repeated here, for brevity.

In some embodiments, the CSI driver 123 may leverage data provided with a PV specification (e.g., PV specification 200 of FIG. 2) for LNet setup. A package manifest may reference a Persistent Volume Claim (PVC). When the package is scheduled, the node agent 130 may read the specification and identify the PVC. An API call may be made to API server 120 to identify the PVC corresponding to the package and the PV that is bound to the PVC. Based on the identification, node agent 130 may invoke the functionality of CSI driver 123 to stage the PV by issuing a CSI request (e.g., nodeStageVolumeRequest) that instructs the CSI driver 123 to prepare the PV for mounting to a global path on the node, making it accessible to the containers of the package scheduled on the worker node 108A. Node agent 130 may pass PV attributes to the CSI driver 123 in the CSI request which may be used by the CSI driver 123 to perform LNet setup. The particular operations performed by the CSI driver 123 are discussed in further detail in connection with FIG. 5.

FIG. 2 is an example persistent volume specification 200, in accordance with at least one embodiment. A Persistent Volume (PV) specification may be an object of the container orchestration platform 100 of FIG. 1 that defines various attributes of a storage resource within the cluster, including its capacity, access modes, and storage class. PV specification 200 identifies a name for the PV (e.g., “lustre-pv-example,” depicted at 202), a capacity (e.g., “771 Gi,” depicted at 204), a volume mode (e.g., “Filesystem,” depicted at 206), an access mode (e.g., “ReadWriteMany,” depicted at 208), and a volume reclaim policy (e.g., “Retain,” depicted at 210), although any suitable attribute of the PV may be provided in the PV specification 200.

PV specification 200 may include Container Storage Interface (CSI) data 212. In some embodiments, CSI data 212 may include a driver identifier (e.g., “lustre.csi.cloud.com,”depicted at 214), a volume handle (e.g., “10.0.2.6@tcp1:10.0.2.7@tcp1:/user,” depicted at 216), a filesystem type (e.g., “lustre,” depicted at 218), and volume attributes such as a setup LNet flag (depicted at 220) and a lustre subnet CIDR (e.g., “10.0.8.0/24,” depicted at 222). The lustre subnet CIDR may represent a subnet mask and may be used with the IP address(es) and conventional techniques to identify a subnet range for the Lustre filesystem.

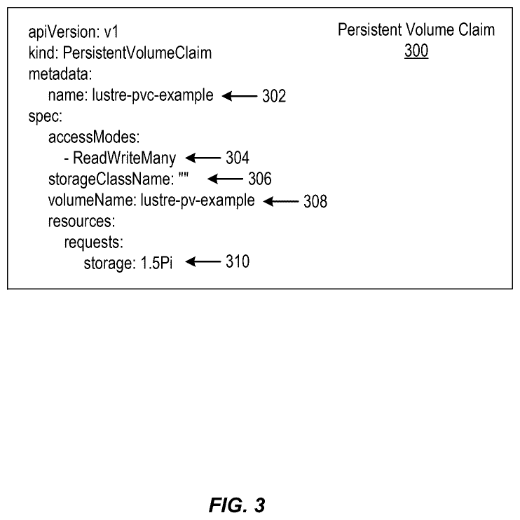

FIG. 3 is an example persistent volume claim 300, in accordance with at least one embodiment. A Persistent Volume Claim (PVC) represents a request for a storage resource which may include attributes of the storage resource requested. A PVC may include an identifier/name (e.g., “lustre-pvc-example,” as depicted at 302) which may uniquely identify the PVC. Additional attributes may include, but are not limited to, an access mode (e.g., “ReadWriteMany,” as depicted at 304), a storage class name (e.g., “” as depicted at 306), a volume name (e.g., “lustre-pv-example,” as depicted at 308), and a storage attributes such as size (e.g., “1.5 Pi,” as depicted at 310). As depicted in FIG. 3, the volume name may reference the name of the PV to which the PVC is bound (e.g., the PV corresponding to PV specification 200 of FIG. 2).

FIG. 4 is an example package manifest 400 that references a persistent volume claim, in accordance with at least one embodiment. A package manifest (e.g., a pod manifest) includes resource requests for the package (e.g., a Kubernetes pod). Package manifest 400 includes an identifier/name for the package (e.g., “lustre-app-example,” depicted at 402), command data 404 (which may include command(s) (e.g., executable programs that the container(s) within the package will run) and, as depicted, arguments to be passed to the command), an image path (e.g., “iad.ocir.io/odx-oke/oke-public/busybox:latest,” as depicted at 406), and an image pull policy (e.g., “Always,” as depicted at 408), although other package attributes are contemplated. To use a volume, package manifest 400 incudes volume mount data 410 (e.g., a name “lustre-volume,” as depicted at 412 and a mount path “/lustre/data,” as depicted at 414) and volume data 416, including a name (e.g., “lustre-volume,” corresponding to the name provided at 412, as depicted at 418), and attributes of a corresponding persistent volume claim (e.g., a claim name “lustre-pvc-example,” as depicted at 422). Package manifest 400 is intended to be an example of a package manifest that refers to the PVC 300 of FIG. 3 based at least in part on the providing the PVC claim name “lustre-pvc-example” which corresponds to the name associated with the PVC 300 as depicted at 302 of FIG. 3.

FIG. 5 depicts a code segment illustrating example setup operations 500, in accordance with at least one embodiment. Setup operations 500 may be performed by the CSI driver 123 of FIG. 1 when attempting to configure the worker node (e.g., worker node 108A of FIG. 1) to operate as part of a Lustre distributed storage system.

Operation 502 may be associated with loading an LNet kernel module on the worker node. A kernel module refers to an image for the LNet service that should be installed at the worker node 108A in advance of setup operations 500 being performed. If the kernel module has not been installed on worker node 108A when operation 502 is executed, an error may be issued by the CSI driver executing the operation 502 that indicates that the kernel module is missing at the worker node. The error may be used to notify the user that the image including the kernel module and tools needs to be installed at the worker node.

Operation 504 may be associated with initializing the LNet service in the kernel module. The operation 504 may be used to initialize and configure the LNet module on the system to set up the network connections require for data transfer within a Lustre cluster. Execution operation 504 my activate LNet and allows further configuration using “lnetctl” utility to add networks, pers, and routes, as needed.

Operations 506 may be associated with deleting any previous/stale configurations at the worker node. Operation 508 may be used to display the current status and configuration of the LNet network, providing network configuration data (e.g., network configuration data maintained by the LNet service) that indicates network topology, peer connections, routing details, and overall health of the LNet system. Including “>tcp1.yaml” in the command may cause the data generated through execution the command “lnetctl net show—net tcp1” (e.g., LNet status and configuration data corresponding to LNet “tcp1”) to be stored in a file entitled “tcp1.yaml.” Operation 510 may be used to delete any LNet data configured at the worker node that matches the specification described in the file “tcp1.yaml.”

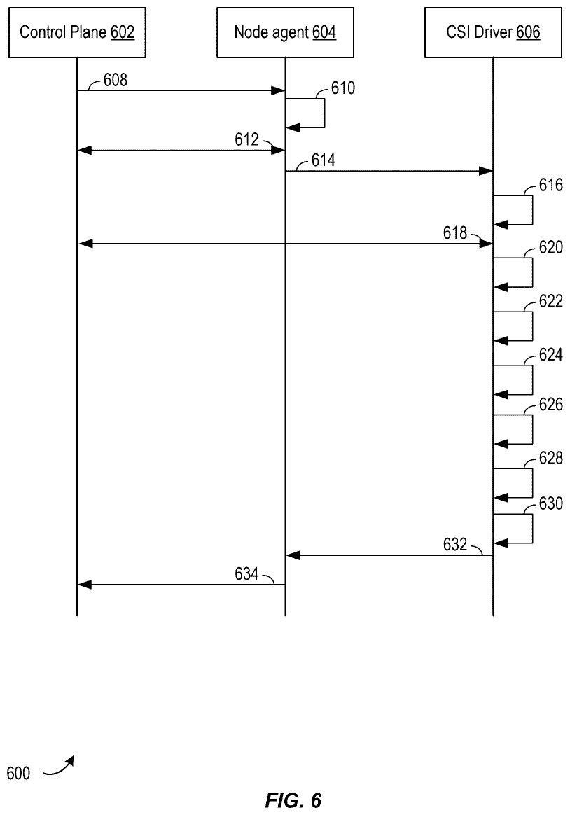

Operations 512 may be associated with adding an LNet entry using an interface name of a secondary VNIC (e.g., one of the network interface(s) 117 of FIG. 1 that is attached and is intended to be used for LNet communications). Obtaining the interface name for the secondary VNIC is discussed in more detail with respect to FIG. 6. If the secondary VNIC is unavailable, operation 512 may fail and the CSI driver may issue a corresponding error. Adding an LNet entry through the executing operation 512 may create a virtual network interface that uses the TCP protocol for communication between Lustre client nodes, setting up a new communication channel within the LNet system (e.g., a communication channel labeled “tcp1”) that can be used by the cluster nodes to exchange data.

Operations 514 may be associated with verifying that the LNet communication channel has been configured. Executing operation 514 may be used to display the network identifiers (NIDS) currently accessible on the local node (e.g., worker node 108A) within the Lustre network. If a communication channel with the LNet label (e.g., in this example, “tcp1”) does not exist in the list, then a determination may be made that the setup operations 500 have failed and the CSI driver may issue an error indicating the same. If the communication channel is included in the list, then a determination may be made that setup operations 500 were performed successfully and LNet has been successfully configured at the worker node.

FIG. 6 is a flow diagram illustrating an example method 600 for configuring LNet at a worker node, in accordance with at least one embodiment. The method 600 may be performed control plane 602, node agent 604, and CSI driver 606. Control plane 602 may include any suitable component of the control plane 102 of FIG. 1 (e.g., API server 120 of FIG. 1). Node agent 604 may be an example of node agent 130 of FIG. 1. CSI driver 606 may be an example of the CSI driver 123 of FIG. 1. Actions described as being performed by the control plane 602, the node agent 604, and/or the CSI driver 606 may be performed by one or more processors of a computing device on which the respective component is executed. It is assumed that a PVC (e.g., PVC 300 of FIG. 3) has been created and bound to a particular PV (e.g., a PV represented by the PV specification 200 of FIG. 2), through a provisioning process performed by the control plane 602 to provision resources for the package corresponding to package manifest 400 in advance of executing the operations of method 600. In some embodiments, during that process, the PV and/or PVC may be associated with one another in a one-to-one mapping. When bound, the PV specification 200 and/or the PVC 300 may be modified to reference an identifier of the other (e.g., a name). By way of example, PVC 300 may be modified to reference a PV a depicted at 308 of FIG. 3.

Method 600 may begin at 608, when a package manifest (e.g., package manifest 400) is provided by control plane 602 (e.g., API server 120) to node agent 604. In some embodiments, the package manifest may be provided as part of a process conducted to schedule the corresponding package for execution at a worker node (e.g., worker node 108A on which node agent 604 executes). In some embodiments, at least some of the operations of method 600 (e.g., 610-634) may be performed when the package (e.g., a pod corresponding to a workload) is restarted.

At 610, the node agent 604 may read the package manifest, identifying volume mount data 410 and volume data 416 of FIG. 4.

At 612, using an identifier provided in volume data 416 (e.g., a claim name “lustre-pvc-example,” the node agent 604 may execute an application programming interface (API) call to control plane 602 to identify the PVC (e.g., PVC 300) referenced by the package manifest and the PV that has been bound to the PVC (e.g., the PV represented by PV specification 200).

At 614, the node agent 604 may transmit a node stage volume request to CSI driver 606 (e.g., via a gRPC connection between the two). In some embodiments, the node agent 604 may pass any suitable data of PV specification 200 to CSI driver 606 in the request. By way of example, the volume handle (depicted at 216 of FIG. 2) may be passed to the CSI driver 606 as a parameter of the node stage volume request.

At 616, the CSI driver 606 may begin processing the request. If the PVC 300 and/or PV specification 200 were not included in the request, the CSI driver 606 may request any suitable combination of the data of PVC 300 and/or PV specification 200 at 618. In some embodiments, CSI driver 606 may obtain PV specification 200 using a volume handle provided in the request.

At 620, the CSI driver 606 may process the volume handle (e.g., the volume handle of the request, the volume handle obtained from the PV specification 200) to identify an LNet label. If no volume handle exists in the request and/or the PV specification 200, the CSI driver may issue a corresponding validation error at 632 to node agent 604, which in turn may transmit data indicative of the validation error to control plane 602 at 634, and the method 600 may conclude. If the PV specification 200 includes and attribute “fsType” that is associated with a value other than a predefined value that indicates a Lustre filesystem type (e.g., “lustre”), the CSI driver 606 may issue a corresponding validation error to node agent 604, which in turn may transmit data indicative of the validation error to control plane 602 at 634, and the method 600 may conclude.

In some embodiments, processing the volume handle may include parsing the volume handle (e.g., a string including “10.0.2.6@tcp1:10.0.2.7@tcp1:/user”) to split the string into sections based on a particular character (e.g., “:”). For example, the string “10.0.2.6@tcp1:10.0.2.7@tcp1:/user” may be split into “10.0.2.6@tcp1” and “10.0.2.7@tcp1”. Any portion of the string including a “/” or occurring after a “/” may be discarded. The split strings may be further validated by parsing each string and splitting on a character “@.” By way of example, “10.0.2.6@tcp1” may be split into “10.0.2.6” and “tcp1,” based on the position of the character “@” within the string. Similarly, “10.0.2.7@tcp1” may be split into “10.0.2.7” and “tcp1,” based on the position of the character “@” within the string. The CSI driver 606 may verify that the first portions of the string(s) (in this example, “10.0.0.6” and “10.0.2.7” are valid IP addresses according to a predefined rule set. If any of the first portions of the string(s) are not valid IP addresses, the CSI driver 606 may issue a corresponding validation error to node agent 604, which in turn may transmit data indicative of the validation error to control plane 602 at 634, and the method 600 may conclude. If the string(s) are valid IP addresses, the CSI driver 606 may determine that the second portion of the string(s) indicate the LNet label (e.g., “tcp1”) to be used to perform LNet configuration operations.

At 622, the CSI driver 606 may obtain the lustre subnet CIDR (e.g., “10.0.8.0/24” in the example depicted at 222 of FIG. 2) from PV specification 200. The CSI driver 606 may determine whether a setup flag of the PV (e.g., “setupLNet” depicted at 220 of FIG. 2) is set to a value of “true.” If the value is set to true, the CSI driver 606 may be configured to identify a network interface using the lustre subnet CIDR provided in the PV specification 200.

To obtain a network interface name that is required for LNet setup operations, the CSI driver 606 may execute a function of a networking package (e.g., golang net package) that obtain network interface data (e.g., a name, hardware address, IP address, and associated flags) for every network interface (e.g., network interface(s) 117 of FIG. 1) of the worker node on which CSI driver 606 executes. Using the lustre subnet CIDR (e.g., when the setupLNet flag is set to “true”), the CSI driver 606 may iterate through the network interface data entries to identify a network interface that is associated with an IP address that falls in the lustre subnet. Once identified, the corresponding name of the interface having an IP address falling within the lustre subnet may be stored for used in subsequent LNet setup operations. In some embodiments, if a lustre subnet CIDR is not provided in the PV specification 200, the CSI driver 606 may be configured to utilize a primary network interface (e.g., a primary VNIC) that is identified in the network interface data.

At 624, the CSI driver 606 may begin LNet setup operations (e.g., setup operations 500 of FIG. 5). In some embodiments, the CSI driver 606 may execute operation 502 of FIG. 5 to load the kernel module (e.g., an image including the kernel module for the LNet service and corresponding tools). If the kernel module load fails, the CSI driver 606 may issue an error to node agent 604 at 632, which in turn may transmit data indicative of the error to control plane 602 at 634, and the method 600 may conclude.

At 626, the CSI driver 606 may execute operation 504 of FIG. 5 to initialize the LNet service of the kernel module. If initialization fails, the CSI driver 606 may issue an error to node agent 604 at 632, which in turn may transmit data indicative of the error to control plane 602 at 634, and the method 600 may conclude.

At 626, the CSI driver 606 may identify whether a previous LNet configuration exists based on executing operation 508 of FIG. 5 using the LNet label (e.g., “tcp1”) identified at 620. If no LNet configuration data exists (e.g., indicating no previous LNet configuration corresponding to the LNet label exists), CSI driver may proceed to execute operations for configuring LNet using the label identified at 620. LNet configuration data may include any suitable combination of a network type or name (e.g., “tcp1”) and one or more network interfaces corresponding to a LNet subnet cider (e.g., “10.0.8.160@tcp1”), and a status indicator that indicates that the LNet is active/up or inactive/down. If the LNet configuration data indicates that a LNet configuration corresponding to the label already exists, the CSI driver 606 may determine whether the network interface data identified for that label match the network interface name and IP address identified at 620 and whether the status of the LNet indicates the LNet is active/up. If the name and IP addresses match and the status indicates the LNet is active/up, then LNet configuration has already been performed and the method 600 may skip to 630 where a mount will be attempted.

If an LNet configuration corresponding to the LNet label exists but is identified as being inactive/down, the CSI driver 606 may be configured to issue an error indicating that the LNet is configured but down. This error may be transmitted to the node agent at 632 and in turn transmitted to the control plane 602 at 634 and the method 600 may conclude.

In some examples, a LNet configuration corresponding to the LNet label may exist but is associated network name with a corresponding IP address that does not match the IP address(es) identified at 620. This may occur when a Secondary VNIC that was previously attached, is detached, and new Secondary VNIC is attached on the worker node, leaving the previous LNet configuration in down state. In these scenarios, the CSI driver 606 may be configured to execute operation 510 of FIG. 5 to delete the entry and the method 600 may continue to 628.

At 628, the CSI driver 606 may execute operation 512 of FIG. 5 to add a LNet configuration corresponding to the network interface to be used for LNet communications. The operation may utilize the interface name identified at 622 (e.g., “nic0.0”) and may result in LNet configuration data being stored that indicates a LNet corresponding to label “tcp1” has been configured with interface “nic 0.0” corresponding to an IP address (e.g., 10.0.2.6). CSI driver 606 may execute operation 514 to obtain a list of the current LNet configuration. The CSI driver 606 may check that an entry corresponding to the operations 512 exists and that the status of the LNet entry is active/up. If the entry does not exist or the entry does exist, but is associated with a status that is different from active/up, the CSI driver 606 may issue an error at 632 to node agent 604 indicating the same. Node agent 604 may transmit data indicative of the error to control plane 602 at 634, and the method 600 may end. This type of error may indicate a problem with the secondary VNIC.

At 630, the CSI driver 606 may execute any suitable additional operations such as mounting the volume to a staging directory at the worker node 108A, formatting the PV, or otherwise preparing it for use. If any of the aforementioned operations executed by the CSI driver 606 fail, the CSI driver 606 may forgo a mount attempt, or the mount, if attempted, may fail, leading to an error being transmitted to node agent 604 at 632, and subsequently to control plane 602 at 634.

At 632, the CSI driver 606 may transmit to node agent 604 an indication that the LNet setup and/or that the staging/mount of PV was successful/unsuccessful. Node agent 604 may transmit similar data to control plane 602 at 634, indicating that the LNet setup and/or that the staging/mount was successful/unsuccessful.

If, for any reason, LNet setup fails, a reconciliation mechanism of the control plane 602 (a process by which current state and desired state are compared and, if different, operations are initiated by the control plane 602 to bring the current state in line with the desired state) may ensure that the operations 616-630 are retried any suitable number of times. By way of example, if the network interface for which LNet setup is to be utilized (e.g., a network interface with an IP address falling in the lustre subnet described at 620) is initially unavailable, the operations of method 600 may be retried until the network interface is available. Determining that the network interface is unavailable may include identifying that no network interface is listed with an IP address that falls within the range indicated by the lustre subnet CIDR at 620.

The operations of method 600 may be used to repair/recover from network failures. As described above, the CSI driver 606 may check the status of the LNet configuration and reconfigures LNet when a new mount is requested or when a workload is restarted. This ensures that LNet remains functional even after changes made to network interfaces or other suitable network disruptions. As an example, when a secondary VNIC used by LNet is deleted or experiences is not functioning anymore, the LNet stops working and the lustre filesystem mounted on the worker node will stop responding. A new secondary VNIC may be attached to the worker node, or, when operational, the previous secondary VNIC may be reconfigured. If the IP address of the VNIC to be used for LNet has changed, the workload will need to be restarted, resulting in method 600 being performed, which will cause the old configuration to be deleted and a new one to be created to configure the new secondary VNIC to be utilized for LNet.

In some embodiments, the CSI driver 606 may be extended to support the ability to customize LNet behavior, such as disabling route configuration in environments where package networking conflicts with the Lustre network.

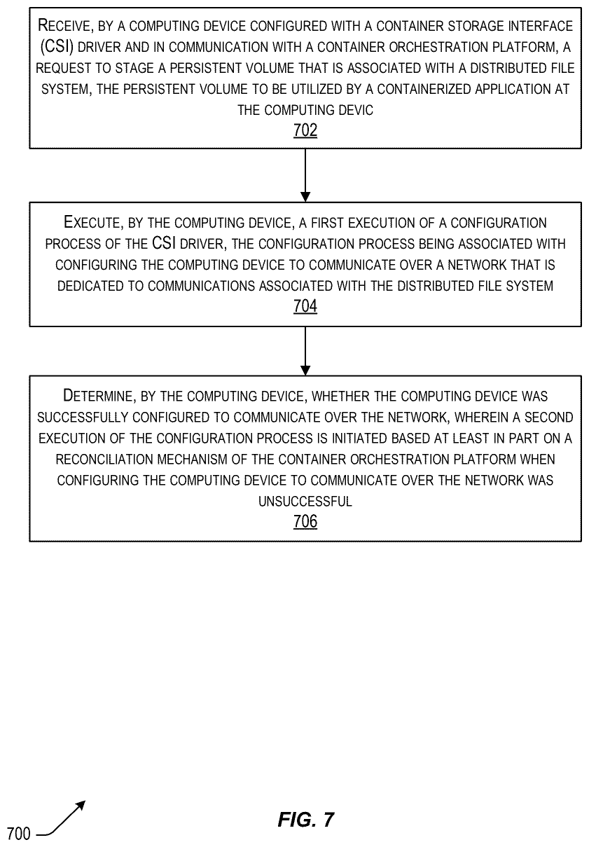

FIG. 7 is a block diagram illustrating an example method 700 for configuring a worker node to execute as part of a network that is associated with a distributed file system, in accordance with at least one embodiment. Method 700 may be performed by executing operations of a Container Storage Interface (CSI) driver (e.g., the CSI driver 123 of FIG. 1, the CSI driver 604 of FIG. 6, etc.). The operations of method 700 may be performed in any suitable order. More or fewer operations than those depicted in FIG. 7 may be included in method 700.

Method 700 may begin at 702, where a computing device configured with a container storage interface (CSI) driver and in communication with a container orchestration platform may receive a request (e.g., a node stage volume request provide by node agent 130 of FIG. 1) to stage a persistent volume (e.g., a Lustre storage volume) that is associated with a distributed file system (e.g., a Lustre parallel distributed file system). In some embodiments, the persistent volume is to be utilized by a containerized application at the computing device (e.g., an application contained by one of container(s) 112A of FIG. 1).

At 704, the computing device may execute a first execution of a configuration process of the CSI driver. In some embodiments, the configuration process is associated with configuring the computing device to communicate over a network (e.g., a Lustre network) that is dedicated to communications associated with the distributed file system. In some embodiments, the network may utilize an LNet network protocol. The configuration process may include any suitable combination of the operations discussed in connection with method 600 of FIG. 6. In some embodiments, executing the configuration process may comprise 1) initiating, by the computing device, execution of a network service based at least in part on an image installed at the computing device, 2) identifying, by the network service executing at the computing device, an identifier for the network, the identifier being identified based at least in part on a persistent volume specification that is associated with the persistent volume to which the request relates, and 3) determining, by the network service and based at least in part on the identifier, whether the computing device has been previously configured to communicate via the network. In some embodiments, executing the configuration process further comprises deleting a previous network configuration when the computing device has been previously configured to communicate via the network. The previous network configuration may be deleted based at least in part on determining that a first network identifier, a first Internet Protocol (IP) address, or a first virtual network interface identifier of the previous network configuration fails to match a second network identifier, a second IP address, or a second virtual network interface identifier with which configuration is being attempted by the configuration process. In some embodiments, executing the configuration process comprises 1) identifying a subnet range associated with the network, wherein the subnet range is identified based at least on a subnet cross inter-domain routing (CIDR) that is associated with the persistent volume (e.g., the lustre subnet CIDR depicted at 222 of FIGS. 2), 2) executing one or more operations to identify virtual network interface data associated with one or more virtual network interfaces attached to the computing device (e.g., a secondary VNIC to be used to communicate on the network), and 3) identifying a virtual network interface identifier to be used for the configuration process based at least in part on identifying a virtual network interface of the one or more virtual network interfaces that falls within the subnet range associated with the network. In some embodiments, the virtual network interface identifier is a name that is associated with the virtual network interface.

At 706, the computing device may determine whether it was successfully configured to communicate over the network. In some embodiments, a second execution of the configuration process is initiated based at least in part on a reconciliation mechanism of the container orchestration platform. The second execution may be initiated based at least in part on determining that the first execution of the configuration process was unsuccessful.

### Additional Methods

Although not depicted in FIG. 7, additional methods are disclosed. A method may comprise receiving a package manifest (e.g., a manifest of a Kubernetes pod, package manifest 400 of FIG. 4) that is associated with one or more containers to be executed at the computing device. In some embodiments, the package manifest identifies a persistent volume (PV) that is associated with a distributed file system (e.g., a PV that is associated with PV specification 200 of FIG. 2). The operations may comprise executing a configuration process provided by the CSI driver based at least in part on receiving the package manifest. The configuration process may include any suitable combination of the setup operations discussed in connection with FIG. 5. In some embodiments, the configuration process is associated with configuring the computing device to communicate over a network that is dedicated to communications associated with the distributed file system. In some embodiments, executing the configuration process causes the one or more processors to 1) identify a subnet range for the network from a persistent volume specification that is associated with the persistent volume, 2) identify a virtual network interface attached to the computing device that falls within the subnet range, and 3) when the virtual network interface is successfully identified, add an entry that identifies the virtual network interface to network configuration data that is associated with the network. The operations executed by the one or more processors may comprise validating that the computing device was successfully configured to communicate over the network based at least in part on the network configuration data.

In some embodiments, identifying the virtual network interface, may comprise executing a network input/output package function (e.g., a function of a golang net package) that is configured to collect network interface data associated with one or more virtual network interfaces attached to the computing device. In some embodiments, the network interface data comprises a respective network identifier (e.g., a name) of each of the one or more virtual network interfaces and a respective Internet Protocol (IP) address corresponding to each of the one or more virtual network interfaces.

In some embodiments, the package manifest is received as part of initiating or restarting execution of the one or more containers at the computing device.

In some embodiments, the distributed file system is a parallel distributed file system (e.g., Lustre) that allows distributed applications to read and write to a single file simultaneously.

In some embodiments, executing the configuration process causes the one or more processors to 1) determine that no virtual network interface that falls within the subnet range is attached to the computing device, 2) halt execution of the configuration process based at least in part on determining that no virtual network interface that falls within the subnet range is attached to the computing device, and 3) transmit an error indicating that the configuration process was unsuccessful. In some embodiments, execution of the configuration process is subsequently reinitiated by the container orchestration platform based at least in part on transmitting the error.

Another method may include receiving a request to stage a persistent volume for use with a containerized application executing at the computing device. In some embodiments, the persistent volume is associated with a distributed file system that utilizes a dedicated network, the dedicated network being dedicated to communications between devices of the distributed file system. The method may comprise determining, from attributes that are associated with the persistent volume to be staged, a network identifier and a subnet range corresponding to the dedicated network. The method may comprise identifying a network interface that is attached to the computing device based at least in part on the subnet range. The method may comprise configuring the computing device to communicate via the dedicated network based at least in part on adding the network identifier and an identifier of the network interface to network configuration data corresponding to the dedicated network. The method may comprise, in response to successfully configuring the computing device to communicate via the dedicated network, mounting the persistent volume to the computing device. In some embodiments, mounting the persistent volume causes the persistent volume to be accessible to the containerized application.

In some embodiments, the method may comprise obtaining the attributes associated with the persistent volume from a persistent volume specification that is maintained by the container orchestration platform.

In some embodiments, configuring the computing device to communicate via the dedicated network is performed in response to receiving the request to stage the persistent volume.

In some embodiments, the request to stage the persistent volume is received as part of a process to restart a workload corresponding to the containerized application.

In some embodiments, configuring the computing device to communicate via the dedicated network further comprises 1) obtaining current network configuration data corresponding to the dedicated network (e.g., the Lustre network), the current network configuration data indicating whether the network interface is currently configured for use with the dedicated network and a state of the dedicated network, 2) identifying that the current network configuration data fails to match the network identifier, and 3) deleting the current network configuration data based at least in part on identifying that the current network configuration data fails to match the network identifier.

In some embodiments, the method may further comprise executing a network service module corresponding to the dedicated network (e.g., the kernel module discussed in connection with FIG. 5), wherein the computing device is configured to communicate via the dedicated network based at least in part on executing operations of the network service module.

Systems, devices, and computer readable media are disclosed, each of which may comprise one or more memories on which instructions corresponding to the methods disclosed herein may be stored. The instructions may be executed by one or more processors of the disclosed systems and devices to execute the methods disclosed herein. One or more computer programs can be configured to perform operations corresponding to the described methods by virtue of including instructions that, when executed one or more processors, cause the one or more processors to perform the operations.

### Example IaaS Architectures

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 8 is a block diagram 800 illustrating an example pattern of an IaaS architecture, according to at least one embodiment. Service operators 802 can be communicatively coupled to a secure host tenancy 804 that can include a virtual cloud network (VCN) 806 and a secure host subnet 808. In some examples, the service operators 802 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 806 and/or the Internet.

The VCN 806 can include a local peering gateway (LPG) 810 that can be communicatively coupled to a secure shell (SSH) VCN 812 via an LPG 810 contained in the SSH VCN 812. The SSH VCN 812 can include an SSH subnet 814, and the SSH VCN 812 can be communicatively coupled to a control plane VCN 816 via the LPG 810 contained in the control plane VCN 816. Also, the SSH VCN 812 can be communicatively coupled to a data plane VCN 818 via an LPG 810. The control plane VCN 816 and the data plane VCN 818 can be contained in a service tenancy 819 that can be owned and/or operated by the IaaS provider.

The control plane VCN 816 can include a control plane demilitarized zone (DMZ) tier 820 that acts as a perimeter network (e.g., portions of a corporate network between the corporate intranet and external networks). The DMZ-based servers may have restricted responsibilities and help keep breaches contained. Additionally, the DMZ tier 820 can include one or more load balancer (LB) subnet(s) 822, a control plane app tier 824 that can include app subnet(s) 826, a control plane data tier 828 that can include database (DB) subnet(s) 830 (e.g., frontend DB subnet(s) and/or backend DB subnet(s)). The LB subnet(s) 822 contained in the control plane DMZ tier 820 can be communicatively coupled to the app subnet(s) 826 contained in the control plane app tier 824 and an Internet gateway 834 that can be contained in the control plane VCN 816, and the app subnet(s) 826 can be communicatively coupled to the DB subnet(s) 830 contained in the control plane data tier 828 and a service gateway 836 and a network address translation (NAT) gateway 838. The control plane VCN 816 can include the service gateway 836 and the NAT gateway 838.

The control plane VCN 816 can include a data plane mirror app tier 840 that can include app subnet(s) 826. The app subnet(s) 826 contained in the data plane mirror app tier 840 can include a virtual network interface controller (VNIC) 842 that can execute a compute instance 844. The compute instance 844 can communicatively couple the app subnet(s) 826 of the data plane mirror app tier 840 to app subnet(s) 826 that can be contained in a data plane app tier 846.

The data plane VCN 818 can include the data plane app tier 846, a data plane DMZ tier 848, and a data plane data tier 850. The data plane DMZ tier 848 can include LB subnet(s) 822 that can be communicatively coupled to the app subnet(s) 826 of the data plane app tier 846 and the Internet gateway 834 of the data plane VCN 818. The app subnet(s) 826 can be communicatively coupled to the service gateway 836 of the data plane VCN 818 and the NAT gateway 838 of the data plane VCN 818. The data plane data tier 850 can also include the DB subnet(s) 830 that can be communicatively coupled to the app subnet(s) 826 of the data plane app tier 846.

The Internet gateway 834 of the control plane VCN 816 and of the data plane VCN 818 can be communicatively coupled to a metadata management service 852 that can be communicatively coupled to public Internet 854. Public Internet 854 can be communicatively coupled to the NAT gateway 838 of the control plane VCN 816 and of the data plane VCN 818. The service gateway 836 of the control plane VCN 816 and of the data plane VCN 818 can be communicatively coupled to cloud services 856.

In some examples, the service gateway 836 of the control plane VCN 816 or of the data plane VCN 818 can make application programming interface (API) calls to cloud services 856 without going through public Internet 854. The API calls to cloud services 856 from the service gateway 836 can be one-way: the service gateway 836 can make API calls to cloud services 856, and cloud services 856 can send requested data to the service gateway 836. But, cloud services 856 may not initiate API calls to the service gateway 836.

In some examples, the secure host tenancy 804 can be directly connected to the service tenancy 819, which may be otherwise isolated. The secure host subnet 808 can communicate with the SSH subnet 814 through an LPG 810 that may enable two-way communication over an otherwise isolated system. Connecting the secure host subnet 808 to the SSH subnet 814 may give the secure host subnet 808 access to other entities within the service tenancy 819.

The control plane VCN 816 may allow users of the service tenancy 819 to set up or otherwise provision desired resources. Desired resources provisioned in the control plane VCN 816 may be deployed or otherwise used in the data plane VCN 818. In some examples, the control plane VCN 816 can be isolated from the data plane VCN 818, and the data plane mirror app tier 840 of the control plane VCN 816 can communicate with the data plane app tier 846 of the data plane VCN 818 via VNICs 842 that can be contained in the data plane mirror app tier 840 and the data plane app tier 846.

In some examples, users of the system, or customers, can make requests, for example create, read, update, or delete (CRUD) operations, through public Internet 854 that can communicate the requests to the metadata management service 852. The metadata management service 852 can communicate the request to the control plane VCN 816 through the Internet gateway 834. The request can be received by the LB subnet(s) 822 contained in the control plane DMZ tier 820. The LB subnet(s) 822 may determine that the request is valid, and in response to this determination, the LB subnet(s) 822 can transmit the request to app subnet(s) 826 contained in the control plane app tier 824. If the request is validated and requires a call to public Internet 854, the call to public Internet 854 may be transmitted to the NAT gateway 838 that can make the call to public Internet 854. Metadata that may be desired to be stored by the request can be stored in the DB subnet(s) 830.

In some examples, the data plane mirror app tier 840 can facilitate direct communication between the control plane VCN 816 and the data plane VCN 818. For example, changes, updates, or other suitable modifications to configuration may be desired to be applied to the resources contained in the data plane VCN 818. Via a VNIC 842, the control plane VCN 816 can directly communicate with, and can thereby execute the changes, updates, or other suitable modifications to configuration to, resources contained in the data plane VCN 818.

In some embodiments, the control plane VCN 816 and the data plane VCN 818 can be contained in the service tenancy 819. In this case, the user, or the customer, of the system may not own or operate either the control plane VCN 816 or the data plane VCN 818. Instead, the IaaS provider may own or operate the control plane VCN 816 and the data plane VCN 818, both of which may be contained in the service tenancy 819. This embodiment can enable isolation of networks that may prevent users or customers from interacting with other users', or other customers', resources. Also, this embodiment may allow users or customers of the system to store databases privately without needing to rely on public Internet 854, which may not have a desired level of threat prevention, for storage.

In other embodiments, the LB subnet(s) 822 contained in the control plane VCN 816 can be configured to receive a signal from the service gateway 836. In this embodiment, the control plane VCN 816 and the data plane VCN 818 may be configured to be called by a customer of the IaaS provider without calling public Internet 854. Customers of the IaaS provider may desire this embodiment since database(s) that the customers use may be controlled by the IaaS provider and may be stored on the service tenancy 819, which may be isolated from public Internet 854.

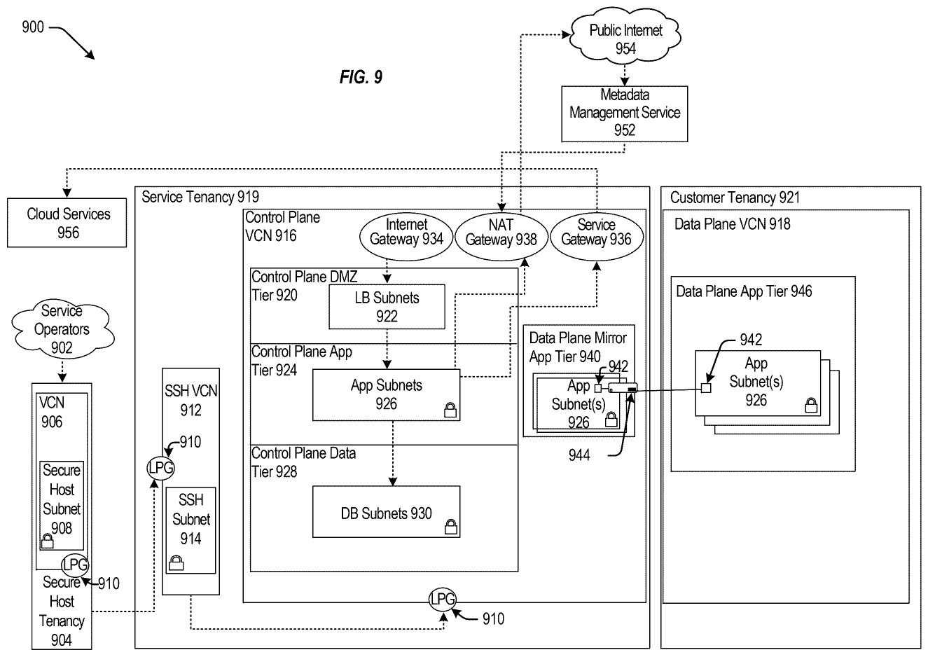

FIG. 9 is a block diagram 900 illustrating another example pattern of an IaaS architecture, according to at least one embodiment. Service operators 902 (e.g., service operators 802 of FIG. 8) can be communicatively coupled to a secure host tenancy 904 (e.g., the secure host tenancy 804 of FIG. 8) that can include a virtual cloud network (VCN) 906 (e.g., the VCN 806 of FIG. 8) and a secure host subnet 908 (e.g., the secure host subnet 808 of FIG. 8). The VCN 906 can include a local peering gateway (LPG) 910 (e.g., the LPG 810 of FIG. 8) that can be communicatively coupled to a secure shell (SSH) VCN 912 (e.g., the SSH VCN 812 of FIG. 8) via an LPG 810 contained in the SSH VCN 912. The SSH VCN 912 can include an SSH subnet 914 (e.g., the SSH subnet 814 of FIG. 8), and the SSH VCN 912 can be communicatively coupled to a control plane VCN 916 (e.g., the control plane VCN 816 of FIG. 8) via an LPG 910 contained in the control plane VCN 916. The control plane VCN 916 can be contained in a service tenancy 919 (e.g., the service tenancy 819 of FIG. 8), and the data plane VCN 918 (e.g., the data plane VCN 818 of FIG. 8) can be contained in a customer tenancy 921 that may be owned or operated by users, or customers, of the system.

The control plane VCN 916 can include a control plane DMZ tier 920 (e.g., the control plane DMZ tier 820 of FIG. 8) that can include LB subnet(s) 922 (e.g., LB subnet(s) 822 of FIG. 8), a control plane app tier 924 (e.g., the control plane app tier 824 of FIG. 8) that can include app subnet(s) 926 (e.g., app subnet(s) 826 of FIG. 8), a control plane data tier 928 (e.g., the control plane data tier 828 of FIG. 8) that can include database (DB) subnet(s) 930 (e.g., similar to DB subnet(s) 830 of FIG. 8). The LB subnet(s) 922 contained in the control plane DMZ tier 920 can be communicatively coupled to the app subnet(s) 926 contained in the control plane app tier 924 and an Internet gateway 934 (e.g., the Internet gateway 834 of FIG. 8) that can be contained in the control plane VCN 916, and the app subnet(s) 926 can be communicatively coupled to the DB subnet(s) 930 contained in the control plane data tier 928 and a service gateway 936 (e.g., the service gateway 836 of FIG. 8) and a network address translation (NAT) gateway 938 (e.g., the NAT gateway 838 of FIG. 8). The control plane VCN 916 can include the service gateway 936 and the NAT gateway 938.

The control plane VCN 916 can include a data plane mirror app tier 940 (e.g., the data plane mirror app tier 840 of FIG. 8) that can include app subnet(s) 926. The app subnet(s) 926 contained in the data plane mirror app tier 940 can include a virtual network interface controller (VNIC) 942 (e.g., the VNIC of 842) that can execute a compute instance 944 (e.g., similar to the compute instance 844 of FIG. 8). The compute instance 944 can facilitate communication between the app subnet(s) 926 of the data plane mirror app tier 940 and the app subnet(s) 926 that can be contained in a data plane app tier 946 (e.g., the data plane app tier 846 of FIG. 8) via the VNIC 942 contained in the data plane mirror app tier 940 and the VNIC 942 contained in the data plane app tier 946.

The Internet gateway 934 contained in the control plane VCN 916 can be communicatively coupled to a metadata management service 952 (e.g., the metadata management service 852 of FIG. 8) that can be communicatively coupled to public Internet 954 (e.g., public Internet 854 of FIG. 8). Public Internet 954 can be communicatively coupled to the NAT gateway 938 contained in the control plane VCN 916. The service gateway 936 contained in the control plane VCN 916 can be communicatively coupled to cloud services 956 (e.g., cloud services 856 of FIG. 8).

In some examples, the data plane VCN 918 can be contained in the customer tenancy 921. In this case, the IaaS provider may provide the control plane VCN 916 for each customer, and the IaaS provider may, for each customer, set up a unique compute instance 944 that is contained in the service tenancy 919. Each compute instance 944 may allow communication between the control plane VCN 916, contained in the service tenancy 919, and the data plane VCN 918 that is contained in the customer tenancy 921. The compute instance 944 may allow resources, that are provisioned in the control plane VCN 916 that is contained in the service tenancy 919, to be deployed or otherwise used in the data plane VCN 918 that is contained in the customer tenancy 921.

In other examples, the customer of the IaaS provider may have databases that live in the customer tenancy 921. In this example, the control plane VCN 916 can include the data plane mirror app tier 940 that can include app subnet(s) 926. The data plane mirror app tier 940 can reside in the data plane VCN 918, but the data plane mirror app tier 940 may not live in the data plane VCN 918. That is, the data plane mirror app tier 940 may have access to the customer tenancy 921, but the data plane mirror app tier 940 may not exist in the data plane VCN 918 or be owned or operated by the customer of the IaaS provider. The data plane mirror app tier 940 may be configured to make calls to the data plane VCN 918 but may not be configured to make calls to any entity contained in the control plane VCN 916. The customer may desire to deploy or otherwise use resources in the data plane VCN 918 that are provisioned in the control plane VCN 916, and the data plane mirror app tier 940 can facilitate the desired deployment, or other usage of resources, of the customer.

In some embodiments, the customer of the IaaS provider can apply filters to the data plane VCN 918. In this embodiment, the customer can determine what the data plane VCN 918 can access, and the customer may restrict access to public Internet 954 from the data plane VCN 918. The IaaS provider may not be able to apply filters or otherwise control access of the data plane VCN 918 to any outside networks or databases. Applying filters and controls by the customer onto the data plane VCN 918, contained in the customer tenancy 921, can help isolate the data plane VCN 918 from other customers and from public Internet 954.

In some embodiments, cloud services 956 can be called by the service gateway 936 to access services that may not exist on public Internet 954, on the control plane VCN 916, or on the data plane VCN 918. The connection between cloud services 956 and the control plane VCN 916 or the data plane VCN 918 may not be live or continuous. Cloud services 956 may exist on a different network owned or operated by the IaaS provider. Cloud services 956 may be configured to receive calls from the service gateway 936 and may be configured to not receive calls from public Internet 954. Some cloud services 956 may be isolated from other cloud services 956, and the control plane VCN 916 may be isolated from cloud services 956 that may not be in the same region as the control plane VCN 916. For example, the control plane VCN 916 may be located in “Region 1,” and cloud service “Deployment 8,” may be located in Region 1 and in “Region 2.” If a call to Deployment 8 is made by the service gateway 936 contained in the control plane VCN 916 located in Region 1, the call may be transmitted to Deployment 8 in Region 1. In this example, the control plane VCN 916, or Deployment 8 in Region 1, may not be communicatively coupled to, or otherwise in communication with, Deployment 8 in Region 2.

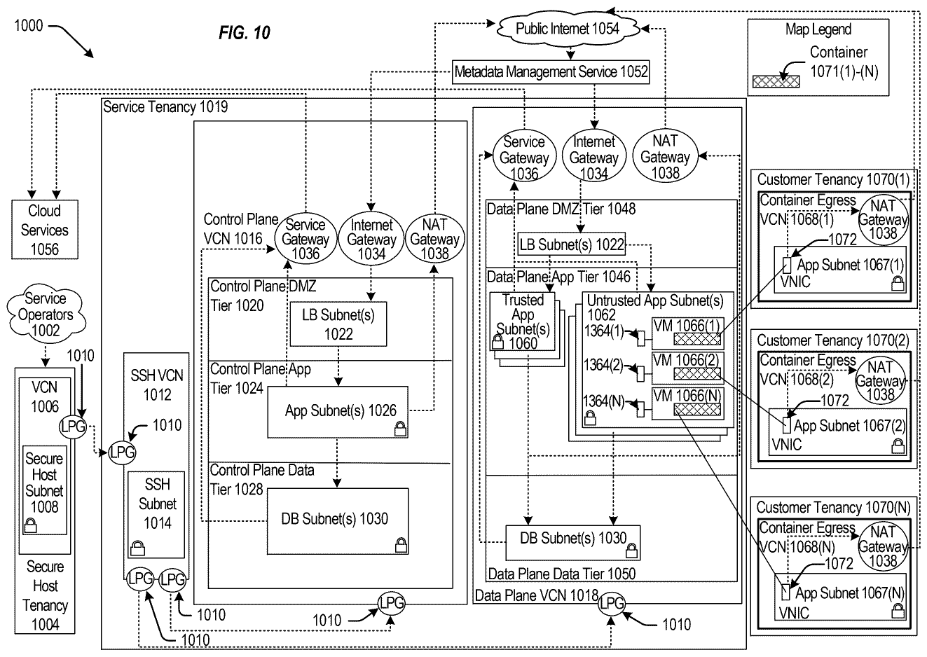

FIG. 10 is a block diagram 1000 illustrating another example pattern of an IaaS architecture, according to at least one embodiment. Service operators 1002 (e.g., service operators 802 of FIG. 8) can be communicatively coupled to a secure host tenancy 1004 (e.g., the secure host tenancy 804 of FIG. 8) that can include a virtual cloud network (VCN) 1006 (e.g., the VCN 806 of FIG. 8) and a secure host subnet 1008 (e.g., the secure host subnet 808 of FIG. 8). The VCN 1006 can include an LPG 1010 (e.g., the LPG 810 of FIG. 8) that can be communicatively coupled to an SSH VCN 1012 (e.g., the SSH VCN 812 of FIG. 8) via an LPG 1010 contained in the SSH VCN 1012. The SSH VCN 1012 can include an SSH subnet 1014 (e.g., the SSH subnet 814 of FIG. 8), and the SSH VCN 1012 can be communicatively coupled to a control plane VCN 1016 (e.g., the control plane VCN 816 of FIG. 8) via an LPG 1010 contained in the control plane VCN 1016 and to a data plane VCN 1018 (e.g., the data plane 818 of FIG. 8) via an LPG 1010 contained in the data plane VCN 1018. The control plane VCN 1016 and the data plane VCN 1018 can be contained in a service tenancy 1019 (e.g., the service tenancy 819 of FIG. 8).

The control plane VCN 1016 can include a control plane DMZ tier 1020 (e.g., the control plane DMZ tier 820 of FIG. 8) that can include load balancer (LB) subnet(s) 1022 (e.g., LB subnet(s) 822 of FIG. 8), a control plane app tier 1024 (e.g., the control plane app tier 824 of FIG. 8) that can include app subnet(s) 1026 (e.g., similar to app subnet(s) 826 of FIG. 8), a control plane data tier 1028 (e.g., the control plane data tier 828 of FIG. 8) that can include DB subnet(s) 1030. The LB subnet(s) 1022 contained in the control plane DMZ tier 1020 can be communicatively coupled to the app subnet(s) 1026 contained in the control plane app tier 1024 and to an Internet gateway 1034 (e.g., the Internet gateway 834 of FIG. 8) that can be contained in the control plane VCN 1016, and the app subnet(s) 1026 can be communicatively coupled to the DB subnet(s) 1030 contained in the control plane data tier 1028 and to a service gateway 1036 (e.g., the service gateway of FIG. 8) and a network address translation (NAT) gateway 1038 (e.g., the NAT gateway 838 of FIG. 8). The control plane VCN 1016 can include the service gateway 1036 and the NAT gateway 1038.

The data plane VCN 1018 can include a data plane app tier 1046 (e.g., the data plane app tier 846 of FIG. 8), a data plane DMZ tier 1048 (e.g., the data plane DMZ tier 848 of FIG. 8), and a data plane data tier 1050 (e.g., the data plane data tier 850 of FIG. 8). The data plane DMZ tier 1048 can include LB subnet(s) 1022 that can be communicatively coupled to trusted app subnet(s) 1060 and untrusted app subnet(s) 1062 of the data plane app tier 1046 and the Internet gateway 1034 contained in the data plane VCN 1018. The trusted app subnet(s) 1060 can be communicatively coupled to the service gateway 1036 contained in the data plane VCN 1018, the NAT gateway 1038 contained in the data plane VCN 1018, and DB subnet(s) 1030 contained in the data plane data tier 1050. The untrusted app subnet(s) 1062 can be communicatively coupled to the service gateway 1036 contained in the data plane VCN 1018 and DB subnet(s) 1030 contained in the data plane data tier 1050. The data plane data tier 1050 can include DB subnet(s) 1030 that can be communicatively coupled to the service gateway 1036 contained in the data plane VCN 1018.

The untrusted app subnet(s) 1062 can include one or more primary VNICs 1064(1)-(N) that can be communicatively coupled to tenant virtual machines (VMs) 1066(1)-(N). Each tenant VM 1066(1)-(N) can be communicatively coupled to a respective app subnet 1067(1)-(N) that can be contained in respective container egress VCNs 1068(1)-(N) that can be contained in respective customer tenancies 1070(1)-(N). Respective secondary VNICs 1072(1)-(N) can facilitate communication between the untrusted app subnet(s) 1062 contained in the data plane VCN 1018 and the app subnet contained in the container egress VCNs 1068(1)-(N). Each container egress VCNs 1068(1)-(N) can include a NAT gateway 1038 that can be communicatively coupled to public Internet 1054 (e.g., public Internet 854 of FIG. 8).

The Internet gateway 1034 contained in the control plane VCN 1016 and contained in the data plane VCN 1018 can be communicatively coupled to a metadata management service 1052 (e.g., the metadata management system 852 of FIG. 8) that can be communicatively coupled to public Internet 1054. Public Internet 1054 can be communicatively coupled to the NAT gateway 1038 contained in the control plane VCN 1016 and contained in the data plane VCN 1018. The service gateway 1036 contained in the control plane VCN 1016 and contained in the data plane VCN 1018 can be communicatively coupled to cloud services 1056.

In some embodiments, the data plane VCN 1018 can be integrated with customer tenancies 1070. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1046. Code to run the function may be executed in the VMs 1066(1)-(N), and the code may not be configured to run anywhere else on the data plane VCN 1018. Each VM 1066(1)-(N) may be connected to one customer tenancy 1070. Respective containers 1071(1)-(N) contained in the VMs 1066(1)-(N) may be configured to run the code. In this case, there can be a dual isolation (e.g., the containers 1071(1)-(N) running code, where the containers 1071(1)-(N) may be contained in at least the VM 1066(1)-(N) that are contained in the untrusted app subnet(s) 1062), which may help prevent incorrect or otherwise undesirable code from damaging the network of the IaaS provider or from damaging a network of a different customer. The containers 1071(1)-(N) may be communicatively coupled to the customer tenancy 1070 and may be configured to transmit or receive data from the customer tenancy 1070. The containers 1071(1)-(N) may not be configured to transmit or receive data from any other entity in the data plane VCN 1018. Upon completion of running the code, the IaaS provider may kill or otherwise dispose of the containers 1071(1)-(N).

In some embodiments, the trusted app subnet(s) 1060 may run code that may be owned or operated by the IaaS provider. In this embodiment, the trusted app subnet(s) 1060 may be communicatively coupled to the DB subnet(s) 1030 and be configured to execute CRUD operations in the DB subnet(s) 1030. The untrusted app subnet(s) 1062 may be communicatively coupled to the DB subnet(s) 1030, but in this embodiment, the untrusted app subnet(s) may be configured to execute read operations in the DB subnet(s) 1030. The containers 1071(1)-(N) that can be contained in the VM 1066(1)-(N) of each customer and that may run code from the customer may not be communicatively coupled with the DB subnet(s) 1030.

In other embodiments, the control plane VCN 1016 and the data plane VCN 1018 may not be directly communicatively coupled. In this embodiment, there may be no direct communication between the control plane VCN 1016 and the data plane VCN 1018. However, communication can occur indirectly through at least one method. An LPG 1010 may be established by the IaaS provider that can facilitate communication between the control plane VCN 1016 and the data plane VCN 1018. In another example, the control plane VCN 1016 or the data plane VCN 1018 can make a call to cloud services 1056 via the service gateway 1036. For example, a call to cloud services 1056 from the control plane VCN 1016 can include a request for a service that can communicate with the data plane VCN 1018.

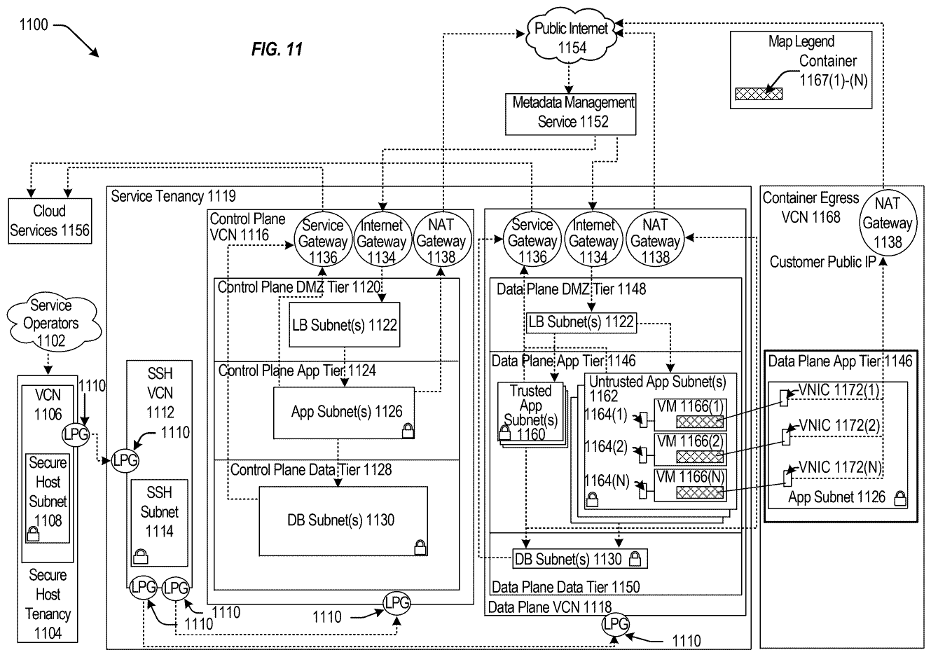

FIG. 11 is a block diagram 1100 illustrating another example pattern of an IaaS architecture, according to at least one embodiment. Service operators 1102 (e.g., service operators 802 of FIG. 8) can be communicatively coupled to a secure host tenancy 1104 (e.g., the secure host tenancy 804 of FIG. 8) that can include a virtual cloud network (VCN) 1106 (e.g., the VCN 806 of FIG. 8) and a secure host subnet 1108 (e.g., the secure host subnet 808 of FIG. 8). The VCN 1106 can include an LPG 1110 (e.g., the LPG 810 of FIG. 8) that can be communicatively coupled to an SSH VCN 1112 (e.g., the SSH VCN 812 of FIG. 8) via an LPG 1110 contained in the SSH VCN 1112. The SSH VCN 1112 can include an SSH subnet 1114 (e.g., the SSH subnet 814 of FIG. 8), and the SSH VCN 1112 can be communicatively coupled to a control plane VCN 1116 (e.g., the control plane VCN 816 of FIG. 8) via an LPG 1110 contained in the control plane VCN 1116 and to a data plane VCN 1118 (e.g., the data plane 818 of FIG. 8) via an LPG 1110 contained in the data plane VCN 1118. The control plane VCN 1116 and the data plane VCN 1118 can be contained in a service tenancy 1119 (e.g., the service tenancy 819 of FIG. 8).

The control plane VCN 1116 can include a control plane DMZ tier 1120 (e.g., the control plane DMZ tier 820 of FIG. 8) that can include LB subnet(s) 1122 (e.g., LB subnet(s) 822 of FIG. 8), a control plane app tier 1124 (e.g., the control plane app tier 824 of FIG. 8) that can include app subnet(s) 1126 (e.g., app subnet(s) 826 of FIG. 8), a control plane data tier 1128 (e.g., the control plane data tier 828 of FIG. 8) that can include DB subnet(s) 1130 (e.g., DB subnet(s) 1030 of FIG. 10). The LB subnet(s) 1122 contained in the control plane DMZ tier 1120 can be communicatively coupled to the app subnet(s) 1126 contained in the control plane app tier 1124 and to an Internet gateway 1134 (e.g., the Internet gateway 834 of FIG. 8) that can be contained in the control plane VCN 1116, and the app subnet(s) 1126 can be communicatively coupled to the DB subnet(s) 1130 contained in the control plane data tier 1128 and to a service gateway 1136 (e.g., the service gateway of FIG. 8) and a network address translation (NAT) gateway 1138 (e.g., the NAT gateway 838 of FIG. 8). The control plane VCN 1116 can include the service gateway 1136 and the NAT gateway 1138.

The data plane VCN 1118 can include a data plane app tier 1146 (e.g., the data plane app tier 846 of FIG. 8), a data plane DMZ tier 1148 (e.g., the data plane DMZ tier 848 of FIG. 8), and a data plane data tier 1150 (e.g., the data plane data tier 850 of FIG. 8). The data plane DMZ tier 1148 can include LB subnet(s) 1122 that can be communicatively coupled to trusted app subnet(s) 1160 (e.g., trusted app subnet(s) 1060 of FIG. 10) and untrusted app subnet(s) 1162 (e.g., untrusted app subnet(s) 1062 of FIG. 10) of the data plane app tier 1146 and the Internet gateway 1134 contained in the data plane VCN 1118. The trusted app subnet(s) 1160 can be communicatively coupled to the service gateway 1136 contained in the data plane VCN 1118, the NAT gateway 1138 contained in the data plane VCN 1118, and DB subnet(s) 1130 contained in the data plane data tier 1150. The untrusted app subnet(s) 1162 can be communicatively coupled to the service gateway 1136 contained in the data plane VCN 1118 and DB subnet(s) 1130 contained in the data plane data tier 1150. The data plane data tier 1150 can include DB subnet(s) 1130 that can be communicatively coupled to the service gateway 1136 contained in the data plane VCN 1118.

The untrusted app subnet(s) 1162 can include primary VNICs 1164(1)-(N) that can be communicatively coupled to tenant virtual machines (VMs) 1166(1)-(N) residing within the untrusted app subnet(s) 1162. Each tenant VM 1166(1)-(N) can run code in a respective container 1167(1)-(N), and be communicatively coupled to an app subnet 1126 that can be contained in a data plane app tier 1146 that can be contained in a container egress VCN 1168. Respective secondary VNICs 1172(1)-(N) can facilitate communication between the untrusted app subnet(s) 1162 contained in the data plane VCN 1118 and the app subnet contained in the container egress VCN 1168. The container egress VCN can include a NAT gateway 1138 that can be communicatively coupled to public Internet 1154 (e.g., public Internet 854 of FIG. 8).

The Internet gateway 1134 contained in the control plane VCN 1116 and contained in the data plane VCN 1118 can be communicatively coupled to a metadata management service 1152 (e.g., the metadata management system 852 of FIG. 8) that can be communicatively coupled to public Internet 1154. Public Internet 1154 can be communicatively coupled to the NAT gateway 1138 contained in the control plane VCN 1116 and contained in the data plane VCN 1118. The service gateway 1136 contained in the control plane VCN 1116 and contained in the data plane VCN 1118 can be communicatively coupled to cloud services 1156.

In some examples, the pattern illustrated by the architecture of block diagram 1100 of FIG. 11 may be considered an exception to the pattern illustrated by the architecture of block diagram 1000 of FIG. 10 and may be desirable for a customer of the IaaS provider if the IaaS provider cannot directly communicate with the customer (e.g., a disconnected region). The respective containers 1167(1)-(N) that are contained in the VMs 1166(1)-(N) for each customer can be accessed in real-time by the customer. The containers 1167(1)-(N) may be configured to make calls to respective secondary VNICs 1172(1)-(N) contained in app subnet(s) 1126 of the data plane app tier 1146 that can be contained in the container egress VCN 1168. The secondary VNICs 1172(1)-(N) can transmit the calls to the NAT gateway 1138 that may transmit the calls to public Internet 1154. In this example, the containers 1167(1)-(N) that can be accessed in real-time by the customer can be isolated from the control plane VCN 1116 and can be isolated from other entities contained in the data plane VCN 1118. The containers 1167(1)-(N) may also be isolated from resources from other customers.

In other examples, the customer can use the containers 1167(1)-(N) to call cloud services 1156. In this example, the customer may run code in the containers 1167(1)-(N) that requests a service from cloud services 1156. The containers 1167(1)-(N) can transmit this request to the secondary VNICs 1172(1)-(N) that can transmit the request to the NAT gateway that can transmit the request to public Internet 1154. Public Internet 1154 can transmit the request to LB subnet(s) 1122 contained in the control plane VCN 1116 via the Internet gateway 1134. In response to determining the request is valid, the LB subnet(s) can transmit the request to app subnet(s) 1126 that can transmit the request to cloud services 1156 via the service gateway 1136.

It should be appreciated that IaaS architectures 800, 900, 1000, 1100 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

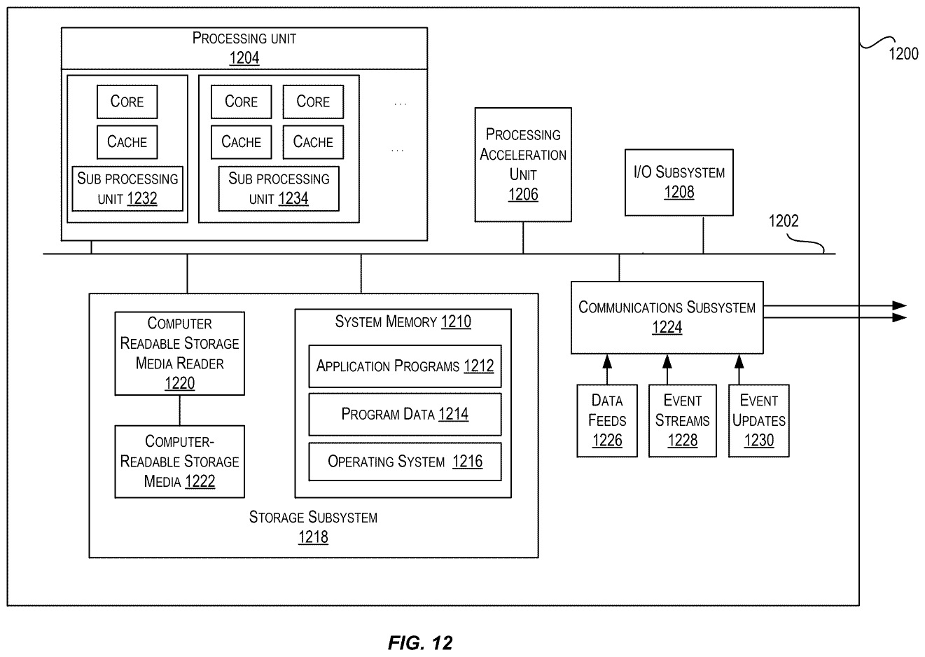

FIG. 12 illustrates an example computer system 1200, in which various embodiments may be implemented. The system 1200 may be used to implement any of the computer systems described above. As shown in the figure, computer system 1200 includes a processing unit 1204 that communicates with a number of peripheral subsystems via a bus subsystem 1202. These peripheral subsystems may include a processing acceleration unit 1206, an I/O subsystem 1208, a storage subsystem 1218 and a communications subsystem 1224. Storage subsystem 1218 includes tangible computer-readable storage media 1222 and a system memory 1210.

Bus subsystem 1202 provides a mechanism for letting the various components and subsystems of computer system 1200 communicate with each other as intended. Although bus subsystem 1202 is shown schematically as a single bus, alternative embodiments of the bus subsystem may utilize multiple buses. Bus subsystem 1202 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1204, which can be implemented as one or more integrated circuits (e.g., a conventional microprocessor or microcontroller), controls the operation of computer system 1200. One or more processors may be included in processing unit 1204. These processors may include single core or multicore processors. In certain embodiments, processing unit 1204 may be implemented as one or more independent processing units 1232 and/or 1234 with single or multicore processors included in each processing unit. In other embodiments, processing unit 1204 may also be implemented as a quad-core processing unit formed by integrating two dual-core processors into a single chip.

In various embodiments, processing unit 1204 can execute a variety of programs in response to program code and can maintain multiple concurrently executing programs or processes. At any given time, some or all of the program code to be executed can be resident in processor(s) 1204 and/or in storage subsystem 1218. Through suitable programming, processor(s) 1204 can provide various functionalities described above. Computer system 1200 may additionally include a processing acceleration unit 1206, which can include a digital signal processor (DSP), a special-purpose processor, and/or the like.

I/O subsystem 1208 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1200 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1200 may comprise a storage subsystem 1218 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1204 provide the functionality described above. Storage subsystem 1218 may also provide a repository for storing data used in accordance with the present disclosure.

As depicted in the example in FIG. 12, storage subsystem 1218 can include various components including a system memory 1210, computer-readable storage media 1222, and a computer readable storage media reader 1220. System memory 1210 may store program instructions that are loadable and executable by processing unit 1204. System memory 1210 may also store data that is used during the execution of the instructions and/or data that is generated during the execution of the program instructions. Various different kinds of programs may be loaded into system memory 1210 including but not limited to client applications, Web browsers, mid-tier applications, relational database management systems (RDBMS), virtual machines, containers, etc.

System memory 1210 may also store an operating system 1216. Examples of operating system 1216 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1200 executes one or more virtual machines, the virtual machines along with their guest operating systems (GOSs) may be loaded into system memory 1210 and executed by one or more processors or cores of processing unit 1204.

System memory 1210 can come in different configurations depending upon the type of computer system 1200. For example, system memory 1210 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1210 may include a basic input/output system (BIOS) containing basic routines that help to transfer information between elements within computer system 1200, such as during start-up.

Computer-readable storage media 1222 may represent remote, local, fixed, and/or removable storage devices plus storage media for temporarily and/or more permanently containing, storing, computer-readable information for use by computer system 1200 including instructions executable by processing unit 1204 of computer system 1200.

Computer-readable storage media 1222 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1222 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1222 may include, but is not limited to, Zip® drives, flash memory cards, universal serial bus (USB) flash drives, secure digital (SD) cards, DVD disks, digital video tape, and the like. Computer-readable storage media 1222 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1200.

Machine-readable instructions executable by one or more processors or cores of processing unit 1204 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1224 provides an interface to other computer systems and networks. Communications subsystem 1224 serves as an interface for receiving data from and transmitting data to other systems from computer system 1200. For example, communications subsystem 1224 may enable computer system 1200 to connect to one or more devices via the Internet. In some embodiments communications subsystem 1224 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1224 can provide wired network connectivity (e.g., Ethernet) in addition to or instead of a wireless interface.

In some embodiments, communications subsystem 1224 may also receive input communication in the form of structured and/or unstructured data feeds 1226, event streams 1228, event updates 1230, and the like on behalf of one or more users who may use computer system 1200.

By way of example, communications subsystem 1224 may be configured to receive data feeds 1226 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1224 may also be configured to receive data in the form of continuous data streams, which may include event streams 1228 of real-time events and/or event updates 1230, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1224 may also be configured to output the structured and/or unstructured data feeds 1226, event streams 1228, event updates 1230, and the like to one or more databases that may be in communication with one or more streaming data source computers coupled to computer system 1200.

Computer system 1200 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1200 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method, comprising:
receiving, by a computing device configured with a container storage interface (CSI) driver and in communication with a container orchestration platform, a request to stage a persistent volume that is associated with a distributed file system, the persistent volume to be utilized by a containerized application at the computing device;
executing, by the computing device, a first execution of a configuration process of the CSI driver, the configuration process being associated with configuring the computing device to communicate over a network that is dedicated to communications associated with the distributed file system; and
determining, by the computing device, whether the computing device was successfully configured to communicate over the network, wherein a second execution of the configuration process is initiated based at least in part on a reconciliation mechanism of the container orchestration platform when configuring the computing device to communicate over the network was unsuccessful.

2. The computer-implemented method of claim 1, wherein the request is formatted according to a node stage volume request of a container storage interface protocol.

3. The computer-implemented method of claim 1, wherein the distributed file system is a Lustre parallel distributed file system, and wherein the network utilizes a Lustre networking protocol.

4. The computer-implemented method of claim 1, wherein executing the configuration process comprises:
initiating, by the computing device, execution of a network service based at least in part on an image installed at the computing device;
identifying, by the network service executing at the computing device, an identifier for the network, the identifier being identified based at least in part on a persistent volume specification that is associated with the persistent volume to which the request relates; and
determining, by the network service and based at least in part on the identifier, whether the computing device has been previously configured to communicate via the network.

5. The computer-implemented method of claim 4, wherein executing the configuration process further comprises deleting a previous network configuration when the computing device has been previously configured to communicate via the network.

6. The computer-implemented method of claim 5, wherein the previous network configuration is deleted based at least in part on determining that a first network identifier, a first Internet Protocol (IP) address, or a first virtual network interface identifier of the previous network configuration fails to match a second network identifier, a second IP address, or a second virtual network interface identifier with which configuration is being attempted by the configuration process.

7. The computer-implemented method of claim 1, wherein executing the configuration process comprises:
identifying a subnet range associated with the network, wherein the subnet range is identified based at least on a subnet cross inter-domain routing (CIDR) that is associated with the persistent volume;
executing one or more operations to identify virtual network interface data associated with one or more virtual network interfaces attached to the computing device; and
identifying a virtual network interface identifier to be used for the configuration process based at least in part on identifying a virtual network interface of the one or more virtual network interfaces that falls within the subnet range associated with the network.

8. A computing device executing a container storage interface (CSI) driver, the computing device being in communication with a container orchestration platform, the computing device comprising
one or more processors; and
one or more memories storing computer-executable instructions that, when executed by the one or more processors, cause the one or more processors to:
receive a package manifest associated with one or more containers to be executed at the computing device, the package manifest identifying a persistent volume that is associated with a distributed file system;
execute a configuration process provided by the CSI driver based at least in part on receiving the package manifest, the configuration process being associated with configuring the computing device to communicate over a network that is dedicated to communications associated with the distributed file system, wherein executing the configuration process causes the one or more processors to:
identify a subnet range for the network from a persistent volume specification that is associated with the persistent volume;
identify a virtual network interface attached to the computing device that falls within the subnet range; and
when the virtual network interface is successfully identified, add an entry that identifies the virtual network interface to network configuration data that is associated with the network; and
validate that the computing device was successfully configured to communicate over the network based at least in part on the network configuration data.

9. The computing device of claim 8, wherein executing the computer-executable instructions that identify the virtual network interface, further causes the one or more processors to execute a network input/output package function that is configured to collect network interface data associated with one or more virtual network interfaces attached to the computing device, wherein the network interface data comprises a respective network identifier of each of the one or more virtual network interfaces and a respective Internet Protocol (IP) address corresponding to each of the one or more virtual network interfaces.

10. The computing device of claim 8, wherein the container orchestration platform is a Kubernetes orchestration platform.

11. The computing device of claim 8, wherein the package manifest is received as part of initiating or restarting execution of the one or more containers at the computing device.

12. The computing device of claim 8, wherein the distributed file system is a parallel distributed file system that allows distributed applications to read and write to a single file simultaneously.

13. The computing device of claim 8, wherein executing the configuration process causes the one or more processors to:
determine that no virtual network interface that falls within the subnet range is attached to the computing device;
halt execution of the configuration process based at least in part on determining that no virtual network interface that falls within the subnet range is attached to the computing device; and
transmit an error indicating that the configuration process was unsuccessful.

14. The computing device of claim 13, wherein execution of the configuration process is subsequently reinitiated by the container orchestration platform based at least in part on transmitting the error.

15. A non-transitory computer readable medium storing computer-executable instructions associated with a container storage interface driver of a data plane associated with a container orchestration platform that, when executed by one or more processors of a computing device, cause the one or more processors to:
receive a request to stage a persistent volume for use with a containerized application executing at the computing device, the persistent volume being associated with a distributed file system that utilizes a dedicated network, the dedicated network being dedicated to communications between devices of the distributed file system;
determine, from attributes that are associated with the persistent volume to be staged, a network identifier and a subnet range corresponding to the dedicated network.
identify a network interface that is attached to the computing device based at least in part on the subnet range;
configure the computing device to communicate via the dedicated network based at least in part on adding the network identifier and an identifier of the network interface to network configuration data corresponding to the dedicated network; and
in response to successfully configuring the computing device to communicate via the dedicated network, mount the persistent volume to the computing device, wherein mounting the persistent volume causes the persistent volume to be accessible to the containerized application.

16. The non-transitory computer readable medium of claim 15, wherein executing the computer-executable instructions further causes the one or more processors to obtain the attributes associated with the persistent volume from a persistent volume specification that is maintained by the container orchestration platform.

17. The non-transitory computer readable medium of claim 15, wherein configuring the computing device to communicate via the dedicated network is performed in response to receiving the request to stage the persistent volume.

18. The non-transitory computer readable medium of claim 15, wherein the request to stage the persistent volume is received as part of a process to restart a workload corresponding to the containerized application.

19. The non-transitory computer readable medium of claim 15, wherein executing the computer-executable instructions that configure the computing device to communicate via the dedicated network further causes the one or more processors to:
obtain current network configuration data corresponding to the dedicated network, the current network configuration data indicating whether the network interface is currently configured for use with the dedicated network and a state of the dedicated network;
identify that the current network configuration data fails to match the network identifier; and
delete the current network configuration data based at least in part on identifying that the current network configuration data fails to match the network identifier.

20. The non-transitory computer readable medium of claim 15, wherein executing the computer-executable instructions further causes the one or more processors to execute a network service module corresponding to the dedicated network, and wherein the computing device is configured to communicate via the dedicated network based at least in part on executing operations of the network service module.
